(19) United States
(12) Patent Application Publication
(10) Pub. No.: US 2026/0136429 A1
(43) Pub. Date: May 14, 2026

(54) METHODS AND APPARATUSES FOR PROVIDING A CAPABILITY RESTRICTED INDICATION FROM MULTI-UNIVERSAL SUBSCRIBER IDENTITY MODULE USER EQUIPMENT TO NETWORK

(71) Applicant: Telefonaktiebolaget LM Ericsson (publ), Stockholm (SE)

(72) Inventors: Alessio TERZANI, Stockholm (SE); Lian ARAUJO, Solna (SE); Muhammad Ali KAZMI, Sundbyberg (SE); Zhixun TANG, Beijing (CN); Tahmineh TORABIAN ESFAHANI, Sollentuna (SE)

(21) Appl. No.: 19/115,609

(22) PCT Filed: Sep. 8, 2023
(86) PCT No.: PCT/SE2023/050888

§ 371 Date: Mar. 26, 2025

(30) Foreign Application Priority Data
Sep. 27, 2022 (WO) PCT/CN2022/121657
Sep. 27, 2022 (WO) PCT/CN2022/121789

(51) Int. Cl. H04W 76/27; H04W 8/22

(52) U.S. Cl. CPC H04W 76/27; H04W 8/22

(57) ABSTRACT

Embodiments described herein relate to methods and apparatuses for indicating capability restricted information. A method in a user equipment comprises establishing or resuming a second service with a second network according to a second subscription; and indicating to the second network that the user equipment has different capabilities for the second service than capabilities previously indicated to a radio access technology node.

### TECHNICAL FIELD

Embodiments described herein relate to methods and apparatuses for providing a capability restricted information from a multi-universal subscriber identity module user equipment to a network.

### BACKGROUND

Multi-USIM—The Third Generation Partnership Project (3GPP) is currently studying in Release 18 (Rel-18) how to best support User Equipments (UEs) that can manage two or more simultaneous subscriptions (also called Multi-Universal Subscriber Identity Module (M-USIM)). A single UE is capable of having two or more subscription credentials and basically to “act” as two UEs within one device/hardware entity. Even though mobile terminals (UEs) with that property exist, most operations are not really optimised as there is no specific standardised support for Multi-USIM, for example to make it easier for UE's to manage two or more subscriptions simultaneously.

Several aspects may be addressed. For example, a UE may need to be provided support to more easily switch between states related to utilisation of subscription 1 (USIM1, connecting to a first Public Land Mobile Network (PLMN1)) and states related to utilisation or communication using subscription 2 (USIM2, connecting to a second PLMN (PLMN2)) as such states may be dependent on, e.g., RRC_CONNECTED in PLMN1 and PLMN2. Such switching may be straightforward, or may not even be necessary, if the UE has the capability of communicating simultaneously towards two networks, using USIM1 and USIM2 simultaneously. For this to work, there may be a need for at least dual receiver and transmitter chains, designed such that frequencies that are used towards both networks don't cause interference to each other and that radio separation is good enough to not cause, e.g., intermodulation effects in the device. Yet other aspects that can be addressed by the standard is to introduce signalling that allows a UE that cannot simultaneously communicate with, e.g., two or more networks, to at least signal a network that it is leaving, or becoming unreachable for that network.

As described in RP-210316, WID: “Support for Multi-SIM devices for LTE/NR” (referred to herein as “Reference 1”), the Release 17 (Rel-17) work on Multi-USIM is focusing on devices with Single-Receiver (Rx)/Single-Transmitter (Tx) or Dual-Rx/Single-Tx. That is, the Dual-Rx/Dual-Tx UEs were out of scope.

In Rel.18, 3GPP is starting the study of enhancements to the existing procedures to allow a Dual-Rx/Dual-Tx M-USIM UE to operate in RRC_CONNECTED state simultaneously in Network A and Network B. In particular, a mechanism will be specified to indicate preference on temporary UE capability restriction, and removal of such restriction, as described in RP-220955, WID: “Dual Transmission/Reception (Tx/Rx) Multi-SIM for NR” (referred to herein as “Reference 2”).

There currently exist certain challenge(s).

In the current framework for Multi-USIM study in Rel-17, it may be assumed that the UE is not able to stay in RRC_CONNECTED in two networks simultaneously, e.g., it may not possible for the UE to receive/send data using one subscription while having an ongoing service with another subscription. For UEs with at least Dual-Tx and Dual-Rx, when reporting UE capabilities, the available resources may be under-utilized.

In particular, at the establishment of the connection with the second network (while keeping the connection with the first one), the UE may be wrongly configured by the second network (e.g. Network B), since the second network bases the UE configuration on the capabilities received during the Registration phase, which might not be valid anymore (e.g. DC cannot be established since the UE can now only use one transceiver in the network).

Furthermore, solutions to this problem have been explored, for example by restricting the capabilities of a Dual-Tx/Dual-Rx UE in Radio Resource Control (RRC) messages, e.g., a UEAssistanceInformation message or a UECapababilityInformation message. However, in these solutions, the reporting UE capability restriction would not be acknowledged. In other words, there is no acknowledgment from the network indicating whether the UE request is received or accepted.

### SUMMARY

Certain aspects of the disclosure and their embodiments may provide solutions to these or other challenges.

The MUSIM UE informs the second network (e.g. Network B) that its capabilities are restricted when setting up or resuming the connection. The notification may be done by adding an indication e.g. in the RRCSetupRequest/RRCResumeRequest message. The UE may then indicate the actual capability restrictions in the following RRCSetupComplete/RRCResumeComplete messages, or in the UEInformationResponse (if requested by the network), or in the UEAssistanceInformation (if configured by the network), or in the UECapabilityInformation message (if UECapabilityEnquiry is sent by the network).

At establishment or resumption of the connection with the second network (Network B), while keeping the connection with the first network (Network A), the MUSIM UE indicates that its capabilities are restricted (e.g. no Carrier Aggregation (CA) or Dual Connectivity (DC) is possible). Four alternative solutions are described:

### A. One-Bit Notification

1. The UE includes a 1-bit notification in RRCSetupRequest or RRCResumeRequest to indicate to the network that its capabilities are restricted.
2. The network may implement a temporary “basic” configuration for the UE, waiting for the current capabilities from the UE
3. The UE informs the network about the actual capability restrictions in RRCSetupComplete or RRCResumeComplete.
4. The network reconfigures the UE properly, based on the indicated current UE capabilities.

### B. Use of the UEInformationRequest/Response Framework

1. The UE indicates that its capabilities are restricted in RRCSetupComplete, RRCResumeComplete or RRCReconfigurationComplete by using a new information element.
2. The network uses a temporary “basic” configuration for the UE and retrieves the restricted capabilities (or the capabilities currently supported by the UE) by sending the UEInformationRequest message
3. The UE replies with UEInformationResponse message including the restricted capabilities (or the capabilities currently supported).
4. The network reconfigures the UE properly, based on the current UE capabilities

### C. Use of the UEAssistanceInformation Framework

1. The UE indicates that its capabilities are restricted by using a 1-bit notification in RRCSetupComplete or RRCResumeComplete.
2. The network uses a temporary “basic” configuration for the UE and configures the UE to report the restrictions via the UEAssistanceInformation message
3. The UE sends the UEAssistanceInformation message including the restricted capabilities.
4. The network reconfigures the UE properly, based on the current UE capabilities

### D. Use of UECapabilityEnquiry/UECapabilityInformation Framework

1. The UE includes also restricted capabilities e.g., in a separate container and indicating some capabilities are restricted in UECapabilityInformation message
2. The network uses a temporary “basic” configuration for the UE, waiting for the current capabilities from the UE
3. The network reconfigures properly the UE, based on the current UE capabilities.

Certain aspects of the disclosure and their embodiments may provide solutions to these or other challenges. This disclosure provides methods for how a network acknowledges that a Dual-Tx/Dual-Rx (2Tx/2Rx) UE has temporarily restricted or un-restricted (de-restricted) its capabilities for M-USIM purposes. This could be:
an indication in a RRC message, e.g., RRCReconfiguration, to indicate the reconfiguration is due to downgrading the UE configuration to restricted UE capabilities;
an indication in a RRC message, e.g., RRCReconfiguration, to indicate the reconfiguration is due to upgrading the UE configuration to full UE capabilities/unrestricted UE capabilities.

At establishment or resume of the connection with Network B (while keeping the connection with Network A), the M-USIM UE can indicate that its capabilities are restricted (e.g., no Carrier Aggregation (CA) or Dual Connectivity (DC) is possible) and the network acknowledges the UE request for restricting the UE capabilities.

In addition, the network may provide a configuration for both restricted capabilities and full capabilities in a RRCReconfiguration message, and the UE can acknowledge to the network which configuration is applied in a RRCReconfigurationComplete message.

According to some embodiments there is provided a method performed by a user equipment that is adapted to simultaneously use two or more subscriptions to communicate with one or more networks, wherein the UE has an ongoing first service with a first network according to a first subscription. The method comprises establishing or resuming a second service with a second network according to a second subscription; and indicating to the second network that the user equipment has different capabilities for the second service than capabilities previously indicated to a radio access technology node.

According to some embodiments there is provided a method performed by a network node in a second network for communicating with a user equipment, UE, that is adapted to simultaneously use two or more subscriptions to communicate with one or more networks, wherein the UE has an ongoing first service with a first network according to a first subscription. The method comprises establishing or resuming a second service with the UE according to a second subscription; and receiving an indication from the UE that the UE has different capabilities for the second service than capabilities previously indicated to a radio access technology node.

According to some embodiments there is provided a method performed by a user equipment, UE, that is adapted to simultaneously use two or more subscriptions to communicate with one or more networks, wherein the UE has an ongoing service with a first network according to a first subscription and the UE is configured with one or more UE capabilities for the ongoing service. The method comprises sending a first request to the first network, the first request requesting a reduction in the UE capabilities configured for the ongoing service to enable the UE to also communicate according to a second subscription; and receiving a first acknowledgement from the first network, the first acknowledgement indicating whether the request for the reduction in the UE capabilities is accepted or rejected.

According to some embodiments there is provided a method performed by a user equipment, UE, that is adapted to simultaneously use two or more subscriptions to communicate with one or more networks, wherein the UE has a first ongoing service with a first network according to a first subscription and a second ongoing service with a second network according to a second subscription, and wherein one or more UE capabilities of the UE are restricted or disabled to enable the UE to communicate simultaneously according to the first subscription and the second subscription. The method comprises after ending the second ongoing service according to the second subscription, sending a first request to the first network, the first request requesting an increase in the UE capabilities configured for the first ongoing service; and receiving a first acknowledgement from the first network, the first acknowledgement indicating whether the request for the increase in the UE capabilities is accepted or rejected.

According to some embodiments there is provided a method performed by a user equipment, UE, that is adapted to simultaneously use two or more subscriptions to communicate with one or more networks, wherein the UE has an ongoing service with a first network according to a first subscription and the UE is configured with one or more UE capabilities for the ongoing service. The method comprises receiving a reconfiguration message from the first network, the reconfiguration message comprising a first configuration and a second configuration, wherein the first configuration is to configure the UE with one or more UE capabilities, and the second configuration is to configure the UE to disable or restrict one or more of the UE capabilities; selecting one of the first configuration and the second configuration to use for the ongoing service; and sending an acknowledgement to the first network indicating the configuration selected for the ongoing service.

According to some embodiments there is provided a method performed by a radio access network, RAN, node in a first network, wherein a user equipment, UE, has an ongoing service with the first network according to a first subscription and the UE is configured with one or more UE capabilities for the ongoing service. The method comprises receiving a first request from the UE, the first request requesting a reduction in UE capabilities configured for the ongoing service to enable the UE to also communicate according to a second subscription; and sending a first acknowledgement to the UE, the first acknowledgement indicating whether the request for the reduction in the UE capabilities is accepted or rejected.

According to some embodiments there is provided a method performed by a radio access network, RAN, node in a first network, wherein a user equipment, UE, has a first ongoing service with the first network according to a first subscription and a second ongoing service with a second network according to a second subscription, and the UE is configured with one or more UE capabilities for the ongoing services, wherein one or more UE capabilities of the UE are restricted or disabled to enable the UE to communicate simultaneously according to the first subscription and the second subscription. The method comprises receiving a first request from the UE, the first request requesting an increase in the UE capabilities configured for the first ongoing service; and sending a first acknowledgement to the UE, the first acknowledgement indicating whether the request for the increase in the UE capabilities is accepted or rejected.

According to some embodiments there is provided a method performed by a radio access network, RAN, node in a first network, wherein a user equipment, UE, has an ongoing service with the first network according to a first subscription and the UE is configured with one or more UE capabilities for the ongoing service. The method comprises sending a reconfiguration message to the UE, the reconfiguration message comprising a first configuration and a second configuration, wherein the first configuration is to configure the UE with one or more UE capabilities, and the second configuration is to configure the UE to disable or restrict one or more of the UE capabilities; and receiving an acknowledgement from the UE indicating the configuration selected for the ongoing service.

According to some embodiments there is provided a user equipment, UE, that is adapted to simultaneously use two or more subscriptions to communicate with one or more networks. The UE comprises processing circuitry adapted to cause the user equipment to: when the UE has an ongoing first service with a first network according to a first subscription, send a first request to the first network, the first request requesting a reduction in the UE capabilities configured for the ongoing service to enable the UE to also communicate according to a second subscription; and receive a first acknowledgement from the first network, the first acknowledgement indicating whether the request for the reduction in the UE capabilities is accepted or rejected.

According to some embodiments there is provided a user equipment, UE, that is adapted to simultaneously use two or more subscriptions to communicate with one or more networks. The UE comprises processing circuitry adapted to cause the UE to: when the UE has a first ongoing service with a first network according to a first subscription and a second ongoing service with the first network or a second network according to a second subscription, and wherein one or more UE capabilities of the UE are restricted or disabled to enable the UE to communicate simultaneously according to the first subscription and the second subscription, after ending the second ongoing service according to the second subscription, send a first request to the first network, the first request requesting an increase in the UE capabilities configured for the first ongoing service; and receive a first acknowledgement from the first network, the first acknowledgement indicating whether the request for the increase in the UE capabilities is accepted or rejected.

According to some embodiments there is provided user equipment, UE, that is adapted to simultaneously use two or more subscriptions to communicate with one or more networks. The UE comprises processing circuitry adapted to cause the UE to: when the UE has an ongoing service with a first network according to a first subscription and the UE is configured with one or more UE capabilities for the ongoing service, receive a reconfiguration message from the first network, the reconfiguration message comprising a first configuration and a second configuration, wherein the first configuration is to configure the UE with one or more UE capabilities, and the second configuration is to configure the UE to disable or restrict one or more of the UE capabilities; select one of the first configuration and the second configuration to use for the ongoing service; and send an acknowledgement to the first network indicating the configuration selected for the ongoing service.

According to some embodiments there is provided radio access network, RAN, node in a first network. The RAN node comprises processing circuitry adapted to cause the RAN node to: when a user equipment, UE, has an ongoing service with the first network according to a first subscription and the UE is configured with one or more UE capabilities for the ongoing service, receive a first request from the UE, the first request requesting a reduction in UE capabilities configured for the ongoing service to enable the UE to also communicate according to a second subscription; and send a first acknowledgement to the UE, the first acknowledgement indicating whether the request for the reduction in the UE capabilities is accepted or rejected.

According to some embodiments there is provided a radio access network, RAN, node in a first network. The RAN node comprises processing circuitry configured to cause the RAN node to: when a user equipment, UE, has a first ongoing service with the first network according to a first subscription and a second ongoing service with the first network or a second network according to a second subscription, and the UE is configured with one or more UE capabilities for the ongoing services, wherein one or more UE capabilities of the UE are restricted or disabled to enable the UE to communicate simultaneously according to the first subscription and the second subscription, receive a first request from the UE, the first request requesting an increase in the UE capabilities configured for the first ongoing service; and send a first acknowledgement to the UE, the first acknowledgement indicating whether the request for the increase in the UE capabilities is accepted or rejected.

According to some embodiments there is provided a radio access network, RAN, node in a first network. The RAN node comprises processing circuitry adapted to cause the RAN node to: when a user equipment, UE, has an ongoing service with the first network according to a first subscription and the UE is configured with one or more UE capabilities for the ongoing service, send a reconfiguration message to the UE, the reconfiguration message comprising a first configuration and a second configuration, wherein the first configuration is to configure the UE with one or more UE capabilities, and the second configuration is to configure the UE to disable or restrict one or more of the UE capabilities; and receive an acknowledgement from the UE indicating the configuration selected for the ongoing service.

According to some embodiments there is provided a user equipment that is adapted to simultaneously use two or more subscriptions to communicate with one or more networks. The UE comprising processing circuitry adapted to cause the UE to: when the UE has an ongoing first service with a first network according to a first subscription, establish or resuming a second service with a second network according to a second subscription; and indicate to the second network that the user equipment has different capabilities for the second service.

According to some embodiments there is provided a network node in a second network for communicating with a user equipment, UE, that is adapted to simultaneously use two or more subscriptions to communicate with one or more networks. The network node comprises processing circuitry adapted to cause the network node to: when the UE has an ongoing first service with a first network according to a first subscription, establish or resume a second service with the UE according to a second subscription; and receive an indication from the UE that the UE has different capabilities for the second service.

Certain embodiments may provide one or more of the following technical advantage(s). The MUSIM UE may be in connected state in (at least) two Networks, and each network may be aware that the UE uses restricted capabilities. In this way, misconfiguration of the UE is avoided.

Certain embodiments may provide one or more of the following technical advantage(s). Reconfiguring the UE, to be simultaneously in RRC_CONNECTED with multiple networks to adapt the configuration of the available radio resources to the UE's current needs and/or situation, e.g. maximizing the throughput for data transmission/reception using one subscription while having/maintaining a phone call with another subscription. The methods also allow the UE to simultaneously operate in RRC_CONNECTED with multiple networks while still meeting the regulatory requirements related to radio exposure to human.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a high-level procedure to allow a Dual-Rx/Dual-Tx M-USIM UE to indicate a preference on a temporary UE capability restriction, so that it can be simultaneously connected to two networks.

FIG. 2 is a flow chart illustrating a method in accordance with some embodiments;

FIG. 3 is a flow chart illustrating a method in accordance with some embodiments;

FIG. 4 illustrates a method in accordance with some embodiments.

FIG. 5 is a flow chart illustrating a method performed by a UE according to various embodiments;

FIG. 6 is a flow chart illustrating a method performed by a UE according to various embodiments;

FIG. 7 is a flow chart illustrating a method performed by a RAN node in a first network according to various embodiments;

FIG. 8 is a flow chart illustrating a method performed by a RAN node in a first network according to various embodiments;

FIG. 9 is a flow chart illustrating a method performed by a RAN node in a first network according to various embodiments;

FIG. 10 shows an example of a communication system in accordance with some embodiments;

FIG. 11 shows a UE in accordance with some embodiments;

FIG. 12 shows a network node in accordance with some embodiments;

FIG. 13 is a block diagram of a host;

FIG. 14 is a block diagram illustrating a virtualization environment in which functions implemented by some embodiments may be virtualized; and

FIG. 15 shows a communication diagram of a host communicating via a network node with a UE over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

In this disclosure, “network A” and “network B” are considered to be two networks with which a Multi-USIM UE is, or can be, simultaneously in RRC_CONNECTED. However, the solutions described herein are also applicable to a case where the UE is connected to more than two networks, and the person skilled in the art will appreciate how the methods would be performed in scenarios with more than two networks.

A UE may have multiple USIMs (i.e. two or more USIMs), and a use case for multiple USIMs is that the different USIMs are associated with different networks, where each network could be a PLMN or a non-public network (NPN). However, it is also possible that a UE has multiple USIMs that are associated with the same network, e.g., a UE has two USIMs from the same operator (for example a user may have one USIM for a personal subscription and another USIM for a work or business subscription) or, e.g., a UE has two USIMs from different operators that use the same radio access network (RAN)—i.e. the different operators share the same RAN. Thus, while many of the examples of the methods described herein are based on the multiple SIMs being associated to different networks, it will be appreciated that the methods can also be applied to scenarios where multiple USIMs are associated with the same network, in which case “network A” and “network B” as used herein refer to a connection to the network using a first USIM (USIM1) and a connection to the network using a second USIM (USIM2) respectively.

Furthermore, in the described examples the networks are PLMNs, but without loss of generality the networks could be any type of network, for example Non-Public Networks (NPNs). Moreover, the two (or more) networks that the UE is connected to may be of different types, e.g. network A can be a PLMN, and network B can be a NPN, or vice versa.

In addition, while the techniques are described with reference to operations, steps and/or actions performed by a network (e.g. network A or network B), it will be appreciated that such operations, steps and/or actions can be performed by a radio access network (RAN) node in the network, i.e. a node in the network that provides a radio interface for the UEs. In a Long Term Evolution (LTE) network the RAN node can be an eNB or eNodeB, and in a New Radio (NR) network the RAN node can be a gNB or gNodeB.

A USIM of a UE can be in the form of a removable hardware USIM (e.g. a SIM card), or it can be an embedded USIM (eUSIM). A particular UE may be able to receive multiple removable hardware USIMs, or have multiple eUSIMs, or may have one or more of both types of USIM.

Reference is made herein to “UE capabilities”, and this refers to different capabilities or functions of the UE that can be activated/enabled/de-restricted and deactivated/disabled/restricted. Examples of UE capabilities that are relevant to the use, or not, of multiple subscriptions/USIMs include the use of Dual Connectivity (DC), the use of Carrier Aggregation (CA), the use of Multiple-Input, Multiple-Output (MIMO), the use of aggregated uplink (UL) and downlink (DL) bandwidth for Frequency Range 1 (FR1) and/or Frequency Range 2 (FR2) carriers, the number of DL and UL Secondary Cells (SCells) in a Master Cell Group (MCG) and Primary Secondary Cells (PSCells)/Secondary Cells (SCell) in a Secondary Cell Group (SCG) for a first frequency Range, FR1, and/or a second frequency range, FR2, a list of carrier frequencies and/or carrier frequency combinations, and UE power classes.

“UE capabilities” may be defined as UE radio access capabilities, which may be further defined as:
A list of containers where each container indicates the UE capabilities for a certain Radio Access Technology (RAT) or Multi-Radio Dual Connectivity (MR-DC)
A UE Capability Information message
which may be segmented
which may contain filters related to what the network requested from UE capabilities
A UE response to UECapabilityEnquiry message
A container stored within the Core Network (CN) and/or RAT node that may be transferred between CN and RAT node
An ID that may refer to one of the bullets above
A structure (e.g. a message, an IE, a container) which contains features divided in multiple granularities e.g. per UE, per band, per Band Combination (BC), per feature set combination, per feature set, per feature set per contiguous carrier (CC)

“Restricted UE capabilities” may be defined as one version of UE capabilities, i.e. UE capabilities containing at least one different feature compared to UE capabilities previously received by a RAT node, where the RAT node is informed that a difference is contained within such UE capabilities. This may be further defined as:
Including only the features that are not supported by the UE
In this manner, a version of UE capabilities can contain e.g. NR-DC support, to indicate the UE does not support NR-DC for that version of UE capabilities. What is supported by the UE does not need to be indicated, since this can be retrieved from UE capabilities previously received by a RAT node.
A list of versions of UE capabilities, for instance:
The UE may include one version of UE capabilities where it indicates support of NR-DC but not NR CA for at least one band combination; in another version, it indicates support of NR CA but not NR-DC for at least one band combination.
The UE may include one version of UE capabilities where it does not include support for features that require 2Tx/2Tx from the UE, e.g. 2 or more MIMO layers.
A registration update procedure, after which the UE may provide to the RAT node a version of UE capabilities upon requested by the RAT node e.g. via UECapabilityEnquiry message.

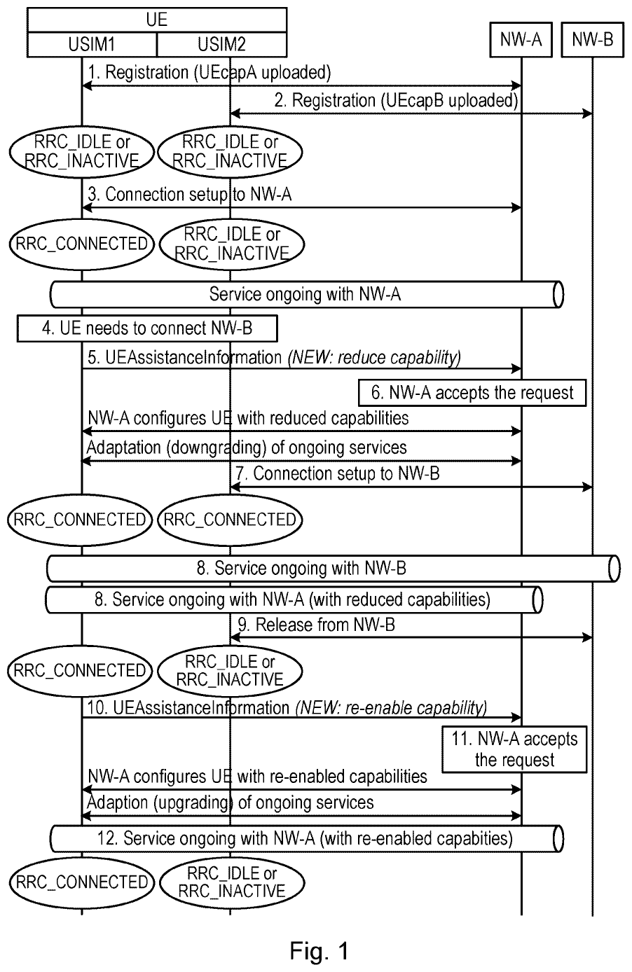

A prior disclosure proposed a high-level procedure to allow a Dual-Rx/Dual-Tx M-USIM UE to indicate a preference on a temporary UE capability restriction, so that it can be simultaneously connected to two networks. The procedure is shown in FIG. 1, and the numbered paragraphs below relate to the respective numbered signals in FIG. 1. The procedure in FIG. 1 relates to a UE that has two USIMs, a USIM1 for network A (NW-A) and a USIM2 for network B (NW-B). The following signalling is shown in FIG. 1.
1. The UE registers to Network A.
   a. The UE uploads UE capabilities (denoted “UEcapA”) relevant for Network A to Network A.
   b. Network A configures UE according to the provided UE capabilities.
2. The UE registers to Network B.
   a. The UE uploads UE capabilities (denoted “UEcapB”) relevant for Network B to Network B.
   b. Network B configures UE according to the provided UE capabilities.

Thus, the UE is registered in the two networks and the relevant UE capabilities have been provided.

The UE may have provided full capabilities to both of the networks.
3. The UE starts service(s) in Network A.
   a. The UE is in RRC_CONNECTED mode only in Network A.
   b. The UE is in RRC_IDLE/RRC_INACTIVE state in Network B. The possible UE behaviours are to: perform camping cell evaluation, perform neighbour cell's measurement, perform paging monitoring, and/or perform System Information Block (SIB) reading for Network B.
4. After some amount of time, the UE needs to connect to Network B.
5. The UE sends UE assistance information (denoted “UEAssistanceInformation”) to Network A requesting that certain capabilities are (temporarily) disabled. The UE assistance information can indicate specific UE capabilities that the UE wants or needs to have disabled.
6. Network A accepts the request and disables (possibly temporarily, i.e. for a defined time period or until a timer expires) certain capabilities of the UE. That is, one or more of the capabilities of the UE that was active or de-restricted prior to the sending of the UE assistance information is disabled/restricted/deactivated by Network A.
   a. Network A can use a RRC Reconfiguration procedure or lower layer means (e.g. a Medium Access Control (MAC) Control Element (CE)/Downlink Control Information (DCI) indication) to configure the UE with reduced capabilities.
   b. Network A or the UE may trigger adaptation (downgrading) for ongoing services in Network A.
7. The UE uses certain capabilities to connect to Network B.
   a. The UE now is in RRC_CONNECTED mode in both networks (Network A and Network B).
   b. Network B can use the RRC Reconfiguration procedure or lower layer means (e.g. MAC CE/DCI indication) to configure the UE with reduced capabilities.
   c. Network B or the UE may trigger adaptation (downgrading) for ongoing services in Network B.
8. The service(s) between UE and Network A continue with reduced capabilities.
9. After some amount of time, services between UE and Network B end, and the UE disconnects from Network B.
   a. The UE is now in RRC_CONNECTED mode in Network A, and in RRC_IDLE/RRC_INACTIVE mode in Network B.
10. The UE may send UE assistance information to Network A requesting that the certain capabilities are re-enabled. That is, the UE may request that one or more of the UE capabilities that are currently restricted or disabled (e.g. one or more of the UE capabilities that was restricted or disabled in step 6) is to be re-enabled. In some embodiments the UE may request that full (i.e. all) UE capabilities are re-enabled for the UE.
11. Network A may accept the UE request and re-enable all of the previously disabled capabilities, or may re-enable just a subset (i.e. one or more, but not all) of those capabilities.
   a. Network A can use the RRC Reconfiguration procedure or lower layer means (e.g. MAC CE/DCI indication) to reconfigure the UE with re-enabled capabilities.
   b. Network A or the UE may trigger adaptation (upgrade) for ongoing services in Network A.
The UE and Network A continue using full (re-enabled) capabilities.

As indicated in the procedure of FIG. 1, the UE registers to the two networks and may provide full capabilities. However, when the UE connects to Network B (while keeping the connection with Network A), it may only be able to operate with restricted capabilities.

Embodiments described herein provide methods to allow the MUSIM UE to indicate, at establishing or resuming of the connection with Network B (e.g. a second network), that its capabilities are restricted. Some embodiments also provide methods to provide an indication of the restricted capabilities. Both the UE side and the Network side are considered.

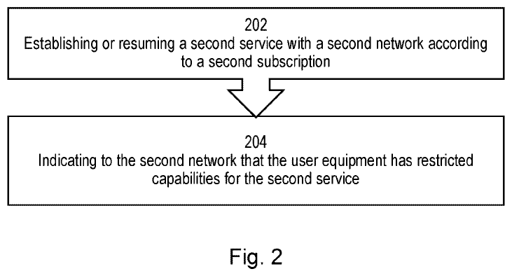

FIG. 2 illustrates a method in accordance with some embodiments

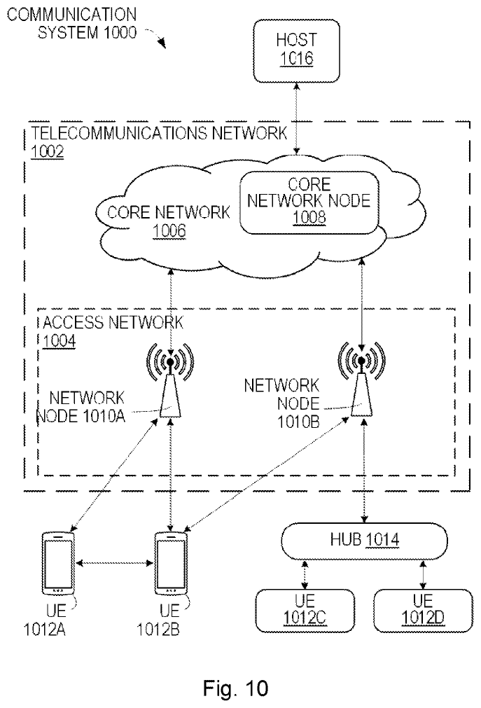

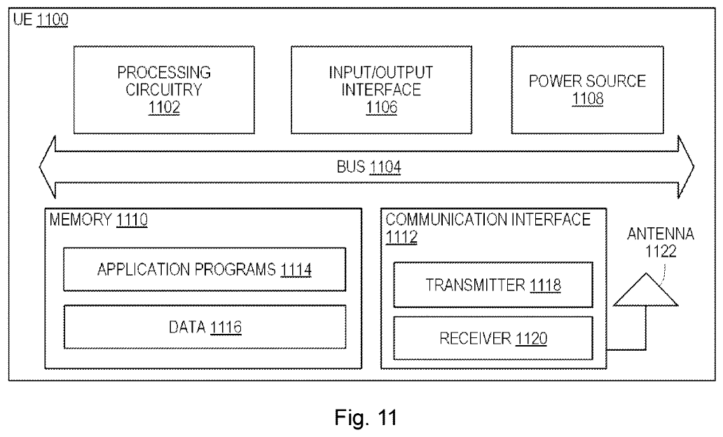

FIG. 2 depicts a method in accordance with particular embodiments. The method of FIG. 2 may be performed by a UE or wireless device (e.g. the UE 1012 or UE 1100 as described later with reference to FIGS. 10 and 11 respectively). The UE may perform the method in response to executing suitably formulated computer readable code. The computer readable code may be embodied or stored on a computer readable medium, such as a memory chip, optical disc, or other storage medium. The computer readable medium may be part of a computer program product. The UE may be configured to simultaneously use two or more subscriptions to communicate with one or more networks, wherein the UE has an ongoing first service with a first network according to a first subscription. The method begins at step 202 with establishing or resuming a second service with a second network according to a second subscription. The first network may be the same as the second network. In step 204 the method comprises indicating to the second network that the user equipment has restricted capabilities for the second service. The first network may be referred to as Network A and the second network may be referred to as Network B.

In some embodiments the method of FIG. 2 further comprises transmitting an indication of first capabilities that are supported in the second service or an indication of second capabilities that are restricted in the second service.

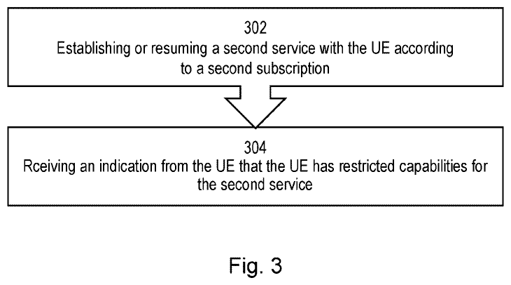

FIG. 3 illustrates a method in accordance with some embodiments.

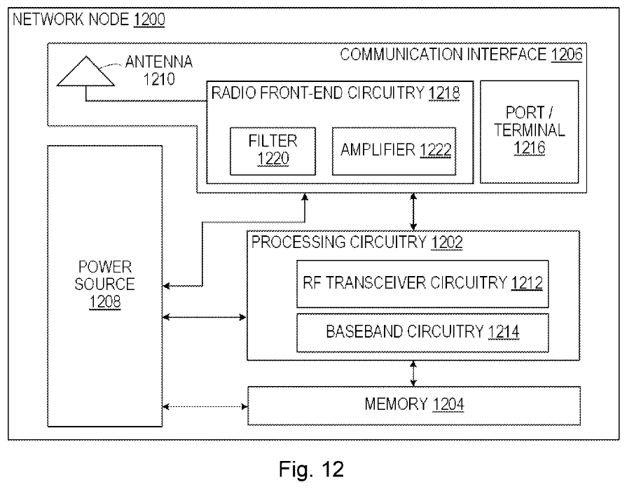

FIG. 3 depicts a method in accordance with particular embodiments. The method of FIG. 3 may be performed by a network node (e.g. the network node 1010 or network node 1200 as described later with reference to FIGS. 10 and 12 respectively). The network node may perform the method in response to executing suitably formulated computer readable code. The computer readable code may be embodied or stored on a computer readable medium, such as a memory chip, optical disc, or other storage medium. The computer readable medium may be part of a computer program product. The network node may be part of a second network and may be configured to communicate with a UE that is configured to simultaneously use two or more subscriptions to communicate with one or more networks, wherein the UE has an ongoing first service with a first network according to a first subscription. The method begins at step 302 with establishing or resuming a second service with the UE according to a second subscription. In step 304 the method comprises receiving an indication from the UE that the UE has restricted capabilities for the second service. The first network may be referred to as Network A and the second network may be referred to as Network B. The first network and the second network may be the same network.

In some examples, step 204 or step 304 occurs at setup or resumption of the connection with the second network (e.g. Network B).

In some examples step 204 or step 304 comprises the UE transmitting a 1-bit notification to the second network indicating that that the user equipment has restricted capabilities for the second service.

In some examples, the 1-bit notification is transmitted in one of: an RRCSetupRequest message (e.g. if in RRC_IDLE), an RRCResumeRequest message (e.g. if in RRC_INACTIVE), RRCSetupComplete message, an RRCResumeComplete message or an RRCReconfigurationComplete message.

In some examples, if the UE included the 1-bit notification in RRCSetupRequest or RRCResumeRequest, the UE may transmit a list of capabilities that are restricted in the following RRCSetupComplete or RRCResumeComplete message. In another alternative the UE sends the list of features that are currently supported in RRCSetupComplete or RRCResumeComplete message. In other words, responsive to transmitting the 1-bit notification in an RRCSetupRequest message or an RRCResumeRequest message, transmitting, in a message, the indication of first capabilities that are supported in the second service or the indication of second capabilities that are not supported in the second service. The message may comprise an RRCSetupComplete or an RRCResumeComplete message.

In some examples step 204 or step 304 comprises the UE transmitting an information element to the second network indicating that that the user equipment has restricted capabilities for the second service. The information element may be transmitted in one of: RRCSetupComplete message, an RRCResumeComplete message or an RRCReconfigurationComplete message. The information element may indicate that one or more types of capabilities are restricted. In other words, the information element may notify that some types of capabilities are restricted (e.g., Component Carrier (CC) restriction, Bandwidth (BW) restriction, etc.), but not the actual values of the restrictions.

In some embodiments, the first capabilities that are supported in the second service are transmitted in a UECapabilityInformation message. In some example, the UE transmits the indication of the first capabilities in response to receiving a UECapabilityEnquiry message from the second network. For example, the UE may transmit a list of the first capabilities that are currently supported in a UECapabilityInformation message e.g., the restricted UE capabilities, if UECapabilityEnquiry was received by the network. A new Information Element may used in UECapabilityInformation to carry such first capabilities, wherein the indication of the first capabilities comprises an indication that the first capabilities are a subset of a set of normal UE capabilities in the UECapabilityInformation message.

In another example, the UE may include both the normal UE capabilities and the first capabilities in separate entities in UECapabilityInformation message. In another example, the UE may include both the normal UE capabilities and first capabilities in a same list e.g., the UE may include an indication for each of the normal UE capabilities that comprises one of the first capabilities.

In some embodiments, the UE may transmit first capabilities or second capabilities in a UEAssistanceInformation message, for example, if configured to do so by the second network.

In some embodiments the UE may transmit the indication of the first capabilities or the indication of the second capabilities responsive to receiving a request to report first capabilities or second capabilities. For example, the UE may receive a UEInformationRequest message from the second network (e.g., serving cell in network B).

For example, a UEInformationRequest message may comprise an indication that second capabilities should be reported. Based on the request, the UE may transmit a UEInformationResponse message providing an indication of the second capabilities. In some examples, the UEInformationRequest message may comprise a request to report the first capabilities. Based on the request, the UE may transmit a UEInformationResponse message providing the first capabilities.

In some examples, the indication of the first capabilities or second capabilities transmitted by the UE to the second network may comprise one or more of the following:
a maximum aggregated bandwidth across all downlink and uplink carrier(s) of a first frequency range, FR1, and/or a second frequency range, FR2 (FR1 defines bands in the sub-6 GHZ spectrum (although 7125 MHz may be a maximum) and FR2 defines bands in the mmWave spectrum);
a maximum number of downlink and uplink secondary cells in a master cell group and/or a maximum number of downlink and uplink primary cells and secondary cells in a secondary cell group for a first frequency range, FR1 and/or a second frequency range, FR2;
a maximum number of receiving, Rx, chains or panels for a second frequency range, FR2;
a list of carrier frequencies and/or carrier frequency combinations that need to be released;
a list of band combinations on whether measurement gap/Network Controlled Small Gap (NCSG) is needed for a target New Radio (NR)/Evolved-UMTS Terrestrial Radio Access (E-UTRA) band that need to be updated;
one or more restricted UE power classes for operation in the second network. The restricted power class(es) may be indicated by the UE as per UE (e.g. applied to all bands), per band (e.g. applies to specific band) or per band combination (e.g. applies to specific band combination such as certain UL CA configuration). The UE power class may define the maximum output power supported by the UE for transmitting signals when operating on certain frequency band or band combination. Examples of UE power classes are power class 1 (e.g. 31 dBm), power class 1.5 (e.g. 29 dBm), power class 2 (e.g. 26 dBm), power class 3 (e.g. 23 dBm), power class 5 (e.g. 20 dBm), etc. For example, the UE may support and be capable of a maximum UE power class 1.5 (29 dBm) and may indicate that its restricted UE power class is power class 3 and/or power class 2 when operating in network B. In another example, the UE may support and be capable of maximum UE power class 2 (26 dBm) may indicate that its restricted UE power class is power class 3 when operating in network B. Since network A and network B do not coordinate and/or schedule UE independently, therefore restriction in UE power class may enable the UE to meet regulatory requirements related to radiation exposure to humans e.g. electromagnetic power density exposure requirements provided by regulatory bodies such as Specific Absorption Rate (SAR).
a restricted maximum uplink duty cycle, MUDC. In other words, the UE may indicate a restricted maximum uplink duty cycle (MUDC) as part of the reduced UE configuration/capability to enable the UE to perform the operation in network B. The MUDC indicates the maximum percentage of time resources (e.g. symbols, slots, subframes) during a certain evaluation period (e.g. T1 seconds such as 1 second) that can be scheduled for uplink transmission to ensure the UE meets the exposure requirements (e.g. electromagnetic energy absorption requirements such as SAR) specified by regulatory bodies. For example, the UE may support certain maximum value of MUDC (e.g. X1 percentage). However, for operation in network B, the UE may indicate to the network node in the assistance information to use the MUDC lower (restricted) value (e.g. X2 percentage). In one example, X2<X1. In another example, X1=80% while X2=50%. Thanks to the reduced capability/configuration of the MUDC when operating in network B, in one example the UE may be able to use its maximum UE power class (e.g. PC 1.5). In another example the UE may indicate to use the restrict UE power class (e.g. PC2 or PC3) even when using restricted MUDC for operation in network B.
a restricted MIMO configuration for the UE operation in the second network. For example, the UE may indicate that the UE may at most be configured with N number of MIMO layers for operating signals in network B. Where N<Nmax; Nmax is the maximum (unrestricted) number of MIMO layers supported by the UE. The parameter N may be the same for uplink and downlink MIMO operation in network B, or N may be different for uplink MIMO operation and downlink MIMO operation in network B e.g. N1 for restricted number of UL downlink MIMO layer and N2 for restricted number of downlink MIMO layers. In one example, N=2 whereas Nmax=4. In another example, N1=1 and N2=2. The UE may have to restrict the MIMO configuration due to insufficient base band resources e.g. when operating on two networks, A and B.
restricted receiving, Rx, chains and/or panels for the UE operation in the second network. For example, the UE may indicate that the UE may at most be configured with N number of Rx chains for operating signals in network B. Where N<Nmax; Nmax is the maximum (unrestricted) number of Rx chains/panels supported by the UE. In one example, N=2 whereas Nmax=4. In another example, N1=1 and N2=2. The UE may have to restrict the Rx chains configuration due to insufficient beam resources e.g. when operating on two networks, A and B.
   a restricted UE receiver configuration for the UE operation the second network. The UE receiver configuration may be characterized by one or more of the following: a number of receivers or receive antenna ports (Rx), an ability to mitigate or cancel or minimize intra-cell interference and/or inter-cell interference or interfering signals (e.g. interference mitigation receiver such as interference rejection and combining (IRC), interference cancellation receiver etc). Examples of interfering signals are reference signals (e.g. CRS) in the serving or interfering cells, signals transmitted by a network node (e.g. a base station (BS)) to other UEs in the serving or interfering cells, inter-MIMO layer or inter-stream interference caused by signals transmitted by a network node to the same UE but on different MIMO/other layers.
   For example, the UE may indicate that the UE may at most use M number of receivers for receiving signals in network B. Where M<Mmax; Mmax is the maximum (unrestricted) number of receivers (e.g. receive antenna ports) supported by the UE. In one example, M=2 whereas Mmax=4. In another example, M=1 and Mmax=2. The UE may have to restrict the UE receiver configuration due to insufficient base band resources e.g. when operating on two networks, A and B.
   In another example, the UE may indicate that the UE cannot perform interference mitigation for receiving signals in network B. The indication about the restricted UE receiver configuration may further indicate that the UE cannot perform certain type of interference mitigation e.g. UE cannot perform inter-cell interference mitigation but can perform intra-cell interference mitigation, UE cannot perform CRS interference cancellation/mitigation etc.
   In another example, the UE may indicate that the UE can receive signals without restricting number of receiver antennas but cannot perform interference mitigation for receiving signals in network B.
   In another example, the UE may indicate that the UE can receive signals with restricted number of receiver antennas but can perform interference mitigation for receiving signals in network B.
a restricted duplex mode, DM, for the UE operation in the second network. The restricted DM may be indicated by the UE as per UE (e.g. applied to all bands), per band (e.g. applies to specific band) or per band combination (e.g. applies to specific band combination such as certain UL CA configuration). Examples of duplex modes are: frequency division duplex (FDD), time division duplex (FDD), half duplex FDD (HD-FDD), full duplex (FD) etc. In FDD mode of operation, the transmission of signals by the device and reception of signals by the same device take place on different carrier frequency channels. In TDD mode of operation, the transmission of signals by the device and reception of signals by the same device take place on the same carrier frequency channel but in different time resources, which do not overlap in time. In HD-FDD mode of operation, the transmission of signals by the device and reception of signals by the same device take place take place on different carrier frequencies as well as on different time resources, which do not overlap in time. In FD mode of operation, the transmission of signals by the device and reception of signals by the same device take place on the same carrier frequency as well as during the same time resource. Some examples of restricted DM as indicated by the UE are:
   For example the UE supporting FDD may indicate that it can operate using only HD-FDD in network B.
   In another example the UE supporting FD may indicate that it can operate using any one of more of HD-FDD, FDD and TDD in network B.
restricted processing capability for the UE operation in the second network. Examples of restricted processing capability are longer processing delay requirements for RRC procedures compared to unrestricted processing capability, longer HARQ feedback delay for reception of DL channel (e.g. PDSCH) compared to unrestricted processing capability, longer channel state indicator (CSI) feedback delay for reporting the CSI results (e.g. Channel Quality Indicator (CQI), rank indicator, L1-Reference Signal Received Power (RSRP), Precoding Matrix Indicator (PMI) etc) compared to unrestricted processing capability etc.
   restricted sidelink (SL) operation in the second network when the UE operates in the second network. SL operation may comprise operating (transmitting to and/or receiving) signals between at least two UEs on sidelink, which is direct communication link between the UEs. Examples of SL operation/communication are V2X, device to device (D2D) etc. The restricted SL operation may comprise any one or more of the following:
   performing any type of SL while operating in network B,
   not performing certain type of SL while operating in network B e.g. not performing SL on shared carrier (between cellular/WAN and SL operations), not performing SL on dedicated carrier (carrier used only on SL operation), not performing SL relay operation (e.g. the UE cannot be configured as SL relay to serve other SL UEs) etc.
   performing SL only on single carrier while operating in network B e.g. not performing SL CA.
   performing SL only on carriers on the same band while operating in network B e.g. not performing inter-band SL CA.
   performing SL only using subset of the SL mode of operations e.g.
   using only broadcast or multicast mode of operation i.e. transmitting and/or receiving broadcast or multicast signals on the SL.
   only using unicast mode of operation i.e. transmitting to and/or receiving from SL another UE in peer to peer communication.
   restricted operation of Ultra-Reliable and Low Latency Communications (URLLC) in the second network when the UE operates in the second network. This enables the UE to use its limited resources to perform and operate enhanced Mobile Broadband (MBB) operation in network B. The restricted URLLC operation may comprise restricted one or more features associated with the URLLC. The restricted feature may comprise any one or more of the following:
   UE cannot support PUCCH cell switching. For example, the UE indicates that it cannot switch PUCCH transmission between PCell, PSCell, PUCCH SCell or the PUCCH sSCell etc.
   UE cannot support PUSCH transmission over duration below threshold (e.g. 7 symbols).
   a restricted measurement capability for the UE operation in the second network for NeedForGaps and/or NCSG (Network Controlled Small Gap) capability. The spare Radio Frequency (RF) chain for measurement on network A may be used for network B processing, and UE may update the band combination status on which band may require the measurement gap or NCSG for measurement.
   When UE reports to support NeedForGaps in network A and further indicates to operate in network B, the Information element (IE) NeedForGapsInfoNR indicates whether measurement gap is required for the UE to perform SSB based measurements on an NR target band should be updated.
   When UE reports to support NCSG in network A and further indicates to operate in network B, the IE NeedForGapNCSG-InfoNR and NeedForGapNCSG-InfoEUTRA indicate whether measurement gap or NCSG is required for the UE to perform SSB based measurements on an target band should be updated.
restricted enhanced measurement capabilities for the UE operation in the second network, such as NeedForGaps and/or NCSG capability. In other words, when UE operates in network B, the enhanced measurement capabilities may be restricted, such as NeedForGaps and/or NCSG capability. The measurement gap for network A may be needed in default regardless of whether UE reporting the band combination status for gap and/or NCSG.

In some examples, the UE may indicate timing information related to or associated with the second capabilities that are restricted in the second service. In other words, when reporting information about any of the restricted capabilities (e.g. in any of the above examples), the UE may further indicate the timing information related to or associated with the restricted capabilities. In one example, the same indicated timing information applies to all the restricted capabilities. In one example, the indicated timing information applies to one or more group of the restricted capabilities. In this (latter) case separate timing information may be indicated for each group of the restricted capabilities. For example, the timing information may indicate the time period (Tp) over which the restricted capabilities are applicable when the UE operates in network B. The UE may further indicate or it may be pre-defined (e.g. in the specification) that during the time outside the indicated time period (Tp), either the UE can operate in network B without any capability restriction, or the UE cannot operate in network B even with the capability restriction, or the UE behaviour is undefined (e.g. UE operation in network B is undefined or is not guaranteed or it may operate in best effort manner or it cannot met requirements) with or without capability restriction. The timing information may comprise one or more of the following timing parameters:
Starting reference time (Ts) e.g. starting time instance when the restricted capabilities are applicable for UE operation in network B. This may also be a future time e.g. to allow the UE to complete one or more ongoing tasks such as post processing data received by the UE from a cell in another network (e.g. network B).
Time period (Tp) over which the restricted capabilities are applicable. Tp starts from Ts.
Ending reference time (Te) e.g. time instance when the restricted capabilities are not more applicable for UE operation in network B. In one example, Te=Tr+Ts.
The parameters, Tr and Te, may be expressed in terms of absolute time such as Coordinated Universal Time (UTC) time, network time or frame counter (e.g. frame number such as System Frame Number (SFN), hyper frame number such as H-SFN, sub-frame number, slot number, combination of SFN or H-SFN and time resource number such as subframe number etc) and/or time resource number (e.g. sub-frame number, slot number, symbol number etc).

In some examples, when the second network (e.g. network node performing the method 3) receives the indication that the UE capabilities are restricted (by means of one of the alternatives above), the second network configures the UE using a “basic” configuration i.e., the UE may be configured by only means of basic, mandatory supported capabilities.

In one embodiment, the network node (e.g., serving cell in network B) waits for the first capabilities or the second capabilities to be received in a RRCSetupComplete or RRCResumeComplete messages from the UE.

In some examples, the network node in the second network may configure the UE to report the first capabilities or second capabilities via an UEAssistanceInformation message.

In some examples, the network node retrieves the first capabilities or second capabilities by sending a UEInformationRequest message. The UEInformationRequest message may comprise an indication of whether the UE should report the first capabilities or the second capabilities.

In some examples the network node retrieves the currently supported capabilities by sending the UEInformationRequest message. The message includes an indication to report the capabilities that are currently supported.

In some examples, the network node may retrieve the capabilities currently supported by the UE by sending the UECapabilityEnquiry message. The UECapabilityEnquiry message may comprise an indication to report the capabilities that are currently supported.

In another embodiment, when the network node (e.g., serving cell in network B) receives the first capabilities or the second capabilities (in RRCSetupComplete/RRCResumeComplete, or in the UEInformationResponse, or in the UEAssistanceInformation), the network node reconfigures the UE properly, by knowing the current (e.g. restricted) UE capabilities.

The network node (e.g., serving cell in network B) may reconfigure the UE based on the first capabilities and/or second capabilities (e.g. restricted UE capabilities) starting from the reference time (Ts) indicated by the UE. The first capabilities and/or second capabilities may be applicable starting from Ts.

The network (e.g. serving cell in network B) may further operate the UE with first capabilities and/or second capabilities over the duration/time period (Tp). Tp is indicated by the UE over which the restriction applied.

The network node (e.g. serving cell in network B) may further stop the UE operation in network B at or before ending reference time (Te). Te may be indicated by the UE after which one or more restrictions do not apply.

In some embodiments, the network node in network B (e.g., Network Node 1) may exchange the first capabilities and/or second capabilities (e.g. the restricted UE capabilities) with a second (target) node in network B (Network Node 2) over Xn interface e.g., via HANDOVER REQUEST, S-NODE ADDITION REQUEST or UE Context Information-Retrieve UE Context Response message.

A nonlimiting implementation example is given below:

This IE contains UE Capability ID as defined in TS 23.003 [22].

| | | | | |
|---|---|---|---|---|
| | | | IE type and | Semantics |
| IE/Group Name | Presence | Range | reference | description |

| | | |
|---|---|---|
| UE Radio | M | OCTET STRING |
| Capability ID | | |
| UE Radio | O | OCTET STRING |
| Restricted | | |
| Capability ID | | |

In some examples, the network node in network B (e.g., Network Node 1) notifies a second (target) node in network B (Network Node 2) that the UE capabilities are restricted, by sending a flag over Xn interface e.g., via HANDOVER REQUEST, S-NODE ADDITION REQUEST or UE Context Information-Retrieve UE Context Response message. Therefore, the Network Node 2 fetches the required UE capabilities.

A nonlimiting implementation example is given below:

This IE contains UE Capability ID as defined in TS 23.003 [22].

| | | | | |
|---|---|---|---|---|
| | | | IE type and | Semantics |
| IE/Group Name | Presence | Range | reference | description |

| | | |
|---|---|---|
| UE Radio | M | OCTET STRING |
| Capability ID | | |
| UE Radio | O | ENUMERATED |
| Restricted | | (true) |
| Capability | | |

Some embodiments described in this disclosure enable a network (e.g. Network A in FIG. 1 above) to acknowledge the UE capability restriction request from the UE (e.g. the request sent/received in step 6). Moreover, the network (e.g. Network A) can reconfigure the UE in CONNECTED state according to the restricted UE capabilities. This restriction of UE capabilities can be temporary, e.g. until a timer expires or a predetermined period of time has passed, or the restriction can be until the UE requests the capabilities are re-enabled. In other words, the techniques described herein comprise methods on how to acknowledge to the UE that the UE configuration is to be downgraded (i.e. the UE capabilities restricted) by the network reconfiguration.

The serving node (e.g. an eNB or a gNB) in Network A can indicate to the UE that the configuration is according to the restricted UE capabilities to enable the UE to perform the connection in/to another network (e.g. network B). In some embodiments, the serving node in network A includes an indication in a RRC message, e.g. a RRCReconfiguration message, that is initiated after the UE requests to restrict its capabilities, and consequently restricts the UE configuration for M-USIM procedures. With this, the network acknowledges to the UE that the restricted capabilities have been accepted/confirmed. Moreover, the UE is reconfigured with the restricted UE capabilities (i.e. one or more of the UE capabilities that were previously enabled, and now restricted/disabled). For instance, in step 6 of FIG. 1 above, the network A can store the received UE assistance information related to reduced capabilities for M-USIM. The restricted configuration is validated and activated with the receipt of a RRC message, e.g. a RRCReconfiguration, by the UE.

In other or further embodiments, when the UE requests to enable the full (or more) UE capabilities due to releasing the operation in another network (e.g. network B), the serving node in network A can acknowledge the UE request via a RRC message, e.g. a RRCReconfiguration message. The network can indicate to the UE that the reconfiguration is according to the un-restricted (de-restricted) UE capabilities. By doing this, the network acknowledges to the UE that the request for un-restricted/de-restricted capabilities has been accepted. Moreover, the UE is reconfigured with full UE capabilities (or at least UE capability that was previous restricted/disabled). For instance, in step 11 of FIG. 1, with receipt of the request to upgrade UE capabilities and applying the network reconfiguration, the UE and Network A continue using full capabilities.

A non-limiting implementation of the above embodiments is shown below. In particular, the data structure of a RRCReconfiguration message is shown, with the underlined parts indicating new fields and elements that can be used to implement the described techniques.

RRCReconfiguration message

-- ASN1START
-- TAG-RRCRECONFIGURATION-START

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |

}
}

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING (CONTAINING |
| CellGroupConfig) | OPTIONAL, -- Cond SCG |
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-IEs |

OPTIONAL
}

| | |
|---|---|
| RRCReconfiguration-v1530-IEs :: = | SEQUENCE { |
| masterCellGroup | OCTET STRING (CONTAINING |
| CellGroupConfig) | OPTIONAL, -- Need M |
| fullConfig | ENUMERATED {true} |

OPTIONAL, -- Cond FullConfig

| | |
|---|---|
| dedicatedNAS-MessageList | SEQUENCE (SIZE (1..maxDRB)) OF |
| DedicatedNAS-Message | OPTIONAL, -- Cond nonHO |
| masterKeyUpdate | MasterKeyUpdate |

OPTIONAL, -- Cond MasterKeyChange

| | |
|---|---|
| dedicatedSIB1-Delivery | OCTET STRING (CONTAINING SIB1) |
| OPTIONAL, -- Need N | |
| dedicatedSystemInformationDelivery | OCTET STRING (CONTAINING |
| SystemInformation) | OPTIONAL, -- Need N |
| otherConfig | OtherConfig |

OPTIONAL, -- Need M

| | |
|---|---|
| nonCriticalExtension | RRCReconfiguration-v1540-IEs |

OPTIONAL
}

| | |
|---|---|
| RRCReconfiguration-v1540-IEs ::= | SEQUENCE { |
| otherConfig-v1540 | OtherConfig-v1540 |

OPTIONAL, -- Need M

| | |
|---|---|
| nonCriticalExtension | RRCReconfiguration-v1560-IEs |

OPTIONAL
}

| | |
|---|---|
| RRCReconfiguration-v1560-IEs :: = | SEQUENCE { |
| mrdc-SecondaryCellGroupConfig | SetupRelease { MRDC- |
| SecondaryCellGroupConfig } | OPTIONAL, -- Need M |
| radioBearerConfig2 | OCTET STRING (CONTAINING |
| RadioBearerConfig) | OPTIONAL, -- Need M |
| sk-Counter | SK-Counter |

OPTIONAL, -- Need N

| | |
|---|---|
| nonCriticalExtension | RRCReconfiguration-v1610-IEs |

OPTIONAL
}

| | |
|---|---|
| RRCReconfiguration-v1610-IEs :: = | SEQUENCE { |
| otherConfig-v1610 | OtherConfig-v1610 |

OPTIONAL, -- Need M

| | |
|---|---|
| bap-Config-r16 | SetupRelease { BAP-Config-r16 } |

OPTIONAL, -- Need M

| | |
|---|---|
| iab-IP-AddressConfigurationList-r16 | IAB-IP-AddressConfigurationList-r16 |

OPTIONAL, -- Need M

| | |
|---|---|
| conditionalReconfiguration-r16 | ConditionalReconfiguration-r16 |

OPTIONAL, -- Need M

| | |
|---|---|
| daps-SourceRelease-r16 | ENUMERATED {true} |

OPTIONAL, -- Need N

| | |
|---|---|
| t316-r16 | SetupRelease {T316-r16} |

OPTIONAL, -- Need M

| | |
|---|---|
| needForGaps ConfigNR-r16 | SetupRelease {NeedForGapsConfigNR-r16} |

OPTIONAL, -- Need M

| | |
|---|---|
| onDemandSIB-Request-r16 | SetupRelease { OnDemandSIB-Request-r16 |

| | |
|---|---|
| } | OPTIONAL, -- Need M |

| | |
|---|---|
| dedicatedPosSys InfoDelivery-r16 | OCTET STRING (CONTAINING |
| PosSystemInformation-r16-IEs) | OPTIONAL, -- Need N |
| sl-ConfigDedicatedNR-r16 | SetupRelease {SL-ConfigDedicatedNR-r16} |

OPTIONAL, -- Need M

| | |
|---|---|
| sl-ConfigDedicatedEUTRA-Info-r16 | SetupRelease {SL-ConfigDedicatedEUTRA- |

| | |
|---|---|
| Info-r16} | OPTIONAL, -- Need M |

| | |
|---|---|
| targetCellSMTC-SCG-r16 | SSB-MTC |

OPTIONAL, -- Need S

| | |
|---|---|
| nonCriticalExtension | RRCReconfiguration-v1700-IEs |

OPTIONAL
}

| | |
|---|---|
| RRCReconfiguration-v1700-IEs ::= | SEQUENCE { |
| otherConfig-v1700 | OtherConfig-v1700 |

OPTIONAL, -- Need M

| | |
|---|---|
| sl-L2RelayUE-Config-r17 | SetupRelease { SL-L2RelayUE-Config-r17 |

| | |
|---|---|
| } | OPTIONAL, -- Need M |

| | |
|---|---|
| sl-L2RemoteUE-Config-r17 | SetupRelease { SL-L2RemoteUE-Config-r17 |

| | |
|---|---|
| } | OPTIONAL, -- Need M |

| | |
|---|---|
| dedicatedPagingDelivery-r17 | OCTET STRING (CONTAINING Paging) |

OPTIONAL, -- Cond PagingRelay

| | |
|---|---|
| needForGapNCSG-ConfigNR-r17 | SetupRelease {NeedForGapNCSG-ConfigNR- |

| | |
|---|---|
| r17} | OPTIONAL, -- Need M |

| | |
|---|---|
| needForGapNCSG-ConfigEUTRA-r17 | SetupRelease {NeedForGapNCSG- |

| | |
|---|---|
| ConfigEUTRA-r17} | OPTIONAL, -- Need M |

| | |
|---|---|
| musim-GapConfig-r17 | SetupRelease {MUSIM-GapConfig-r17} |

OPTIONAL, -- Need M

| | |
|---|---|
| ul-GapFR2-Config-r17 | SetupRelease { UL-GapFR2-Config-r17 } |

OPTIONAL, -- Need M

| | |
|---|---|
| scg-State-r17 | ENUMERATED { deactivated } |

OPTIONAL, -- Need N

| | |
|---|---|
| appLayerMeasConfig-r17 | AppLayerMeasConfig-r17 |

OPTIONAL, -- Need M

| | |
|---|---|
| ue-TxTEG-RequestUL-TDOA-Config-r17 | SetupRelease {UE-TxTEG-RequestUL-TDOA- |

| | |
|---|---|
| Config-r17} | OPTIONAL, -- Need M |

| | |
|---|---|
| nonCriticalExtension | RRCReconfiguration-v1800-IEs |
| } | |

```
RRCReconfiguration-v1800-IEs ::= SEQUENCE {
  RestrictedRRCReconfiguration-IEs ENUMERATED {true, false}
OPTIONAL, -- Need M
  nonCriticalExtension SEQUENCE { }
OPTIONAL
}
```

| | |
|---|---|
| MRDC-SecondaryCellGroupConfig :: = | SEQUENCE { |
| mrdc-ReleaseAndAdd | ENUMERATED {true} |

OPTIONAL, -- Need N

| | |
|---|---|
| mrdc-SecondaryCellGroup | CHOICE { |
| nr-SCG | OCTET STRING (CONTAINING |

RRCReconfiguration),

| | |
|---|---|
| eutra-SCG | OCTET STRING |

}
}

RRCReconfiguration field descriptions

RestrictedRRCReconfiguration
Indicates whether the restricted UE capabilities applies or not. If this field
is set to true, the restricted UE capabilities are applied. If this field is
set to false, the restricted UE capabilities are not applied.

In some embodiments, when the UE connects to Network B (while being in connected state in Network A), the UE can indicate its restricted capabilities to Network B. Network B will further acknowledge the UE restricted capabilities by using the mechanism described in the embodiments above to indicate whether the UE request is accepted or not.

In alternative embodiments, the network can configure the UE with a separate RestrictedRRCReconfiguration container in a RRC message, e.g., RRCReconfiguration, that contains the affected downgraded UE configuration according to the restricted UE capabilities. This container can be in addition to the configuration based on the full capabilities. In other words, Network A can include configurations associated with both full and restricted UE capabilities separately (in separate containers). In this case, the UE should send an acknowledgement to the network via a RRC message, e.g. a RRCReconfigurationComplete message, indicating which configuration has been selected for use. That is, the acknowledgement can indicate to the network whether the downgraded configuration associated with restricted capabilities is to be applied or not.

A non-limiting implementation of the above alternative embodiment is shown below. In particular, the data structure of a RRCReconfiguration message is shown, with the underlined parts indicating new fields and elements that can be used to implement the described techniques.

RRCReconfiguration message

-- ASN1START
-- TAG-RRCRECONFIGURATION-START

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | RRCReconfigurationforMulti-USIM- |

```
v1800
  }
}
RRCReconfigurationforMulti-USIM-v1800-IEs ::= SEQUENCE {
  RestrictedRRCReconfiguration-IEs RRCReconfiguration-IEs
OPTIONAL, -- Need M
  nonCriticalExtension SEQUENCE { }
OPTIONAL
}
```

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING (CONTAINING |
| CellGroupConfig) | OPTIONAL, -- Cond SCG |
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-IEs |

OPTIONAL
}

| | |
|---|---|
| RRCReconfiguration-v1530-IEs ::= | SEQUENCE { |
| masterCellGroup | OCTET STRING (CONTAINING |
| CellGroupConfig) | OPTIONAL, -- Need M |
| fullConfig | ENUMERATED {true} |

OPTIONAL, -- Cond FullConfig

| | |
|---|---|
| dedicatedNAS-MessageList | SEQUENCE (SIZE(1..maxDRB)) OF |
| DedicatedNAS-Message | OPTIONAL, -- Cond nonHO |
| masterKeyUpdate | MasterKeyUpdate |

OPTIONAL, -- Cond MasterKeyChange

| | |
|---|---|
| dedicatedSIB1-Delivery | OCTET STRING (CONTAINING SIB1) |

OPTIONAL, -- Need N

| | |
|---|---|
| dedicatedSystemInformationDelivery | OCTET STRING (CONTAINING |
| SystemInformation) | OPTIONAL, -- Need N |
| otherConfig | OtherConfig |

OPTIONAL, -- Need M

| | |
|---|---|
| nonCriticalExtension | RRCReconfiguration-v1540-IEs |

OPTIONAL
}

| | |
|---|---|
| RRCReconfiguration-v1540-IEs ::= | SEQUENCE { |
| otherConfig-v1540 | OtherConfig-v1540 |

OPTIONAL, -- Need M

| | |
|---|---|
| nonCriticalExtension | RRCReconfiguration-v1560-IEs |

OPTIONAL
}

| | |
|---|---|
| RRCReconfiguration-v1560-IEs ::= | SEQUENCE { |
| mrdc-SecondaryCellGroupConfig | SetupRelease { MRDC- |
| SecondaryCellGroupConfig } | OPTIONAL, -- Need M |
| radioBearerConfig2 | OCTET STRING (CONTAINING |
| RadioBearerConfig) | OPTIONAL, -- Need M |
| sk-Counter | SK-Counter |

OPTIONAL, -- Need N

| | |
|---|---|
| nonCriticalExtension | RRCReconfiguration-v1610-IEs |

OPTIONAL
}

| | |
|---|---|
| RRCReconfiguration-v1610-IEs ::= | SEQUENCE { |
| otherConfig-v1610 | OtherConfig-v1610 |

OPTIONAL, -- Need M

| | |
|---|---|
| bap-Config-r16 | SetupRelease { BAP-Config-r16 } |

OPTIONAL, -- Need M

| | |
|---|---|
| iab-IP-AddressConfigurationList-r16 | IAB-IP-AddressConfigurationList-r16 |

OPTIONAL, -- Need M

| | |
|---|---|
| conditionalReconfiguration-r16 | ConditionalReconfiguration-r16 |

OPTIONAL, -- Need M

| | |
|---|---|
| daps-SourceRelease-r16 | ENUMERATED{true} |

OPTIONAL, -- Need N

| | |
|---|---|
| t316-r16 | SetupRelease {T316-r16} |

OPTIONAL, -- Need M

| | |
|---|---|
| needForGapsConfigNR-r16 | SetupRelease {NeedForGapsConfigNR-r16} |

OPTIONAL, -- Need M

| | |
|---|---|
| onDemandSIB-Request-r16 | SetupRelease { OnDemandSIB-Request-r16 |

| | |
|---|---|
| } | OPTIONAL, -- Need M |

| | |
|---|---|
| dedicatedPosSysInfoDelivery-r16 | OCTET STRING (CONTAINING |
| PosSystemInformation-r16-IEs) | OPTIONAL, -- Need N |
| sl-ConfigDedicatedNR-r16 | SetupRelease {SL-ConfigDedicatedNR-r16} |

OPTIONAL, -- Need M

| | |
|---|---|
| sl-ConfigDedicatedEUTRA-Info-r16 | SetupRelease {SL-ConfigDedicatedEUTRA- |

| | |
|---|---|
| Info-r16} | OPTIONAL, -- Need M |

| | |
|---|---|
| targetCellSMTC-SCG-r16 | SSB-MTC |

OPTIONAL, -- Need S

| | |
|---|---|
| nonCriticalExtension | RRCReconfiguration-v1700-IEs |

OPTIONAL
}

| | |
|---|---|
| RRCReconfiguration-v1700-IEs ::= | SEQUENCE { |
| otherConfig-v1700 | OtherConfig-v1700 |

OPTIONAL, -- Need M

| | |
|---|---|
| sl-L2RelayUE-Config-r17 | SetupRelease { SL-L2RelayUE-Config-r17 |

| | |
|---|---|
| } | OPTIONAL, -- Need M |

| | |
|---|---|
| sl-L2RemoteUE-Config-r17 | SetupRelease { SL-L2RemoteUE-Config-r17 |

| | |
|---|---|
| } | OPTIONAL, Need M |

| | |
|---|---|
| dedicatedPagingDelivery-r17 | OCTET STRING (CONTAINING Paging) |

OPTIONAL, -- Cond PagingRelay

| | |
|---|---|
| needForGapNCSG-ConfigNR-r17 | SetupRelease {NeedForGapNCSG-ConfigNR- |

| | |
|---|---|
| r17} | OPTIONAL, -- Need M |

| | |
|---|---|
| needForGapNCSG-ConfigEUTRA-r17 | SetupRelease {NeedForGapNCSG- |

| | |
|---|---|
| ConfigEUTRA-r17} | OPTIONAL, -- Need M |

| | |
|---|---|
| musim-GapConfig-r17 | SetupRelease {MUSIM-GapConfig-r17} |

OPTIONAL, -- Need M

| | |
|---|---|
| ul-GapFR2-Config-r17 | SetupRelease { UL-GapFR2-Config-r17 } |

OPTIONAL, -- Need M

| | |
|---|---|
| scg-State-r17 | ENUMERATED { deactivated } |

OPTIONAL, -- Need N

| | |
|---|---|
| appLayerMeasConfig-r17 | AppLayerMeasConfig-r17 |

OPTIONAL, -- Need M

| | |
|---|---|
| ue-TxTEG-RequestUL-TDOA-Config-r17 | SetupRelease {UE-TxTEG-RequestUL-TDOA- |

| | |
|---|---|
| Config-r17} | OPTIONAL, -- Need M |

| | |
|---|---|
| nonCriticalExtension | SEQUENCE { } |

OPTIONAL
}

| | |
|---|---|
| MRDC-SecondaryCellGroupConfig ::= | SEQUENCE { |
| mrdc-ReleaseAndAdd | ENUMERATED {true} |

OPTIONAL, -- Need

| | |
|---|---|
| mrdc-SecondaryCellGroup | CHOICE { |
| nr-SCG | OCTET STRING (CONTAINING |

RRCReconfiguration),

| | |
|---|---|
| eutra-SCG | OCTET STRING |

}
}

RRCReconfigurationComplete message

-- ASN1START
-- TAG-RRCRECONFIGURATIONCOMPLETE-START

| | |
|---|---|
| RRCReconfigurationComplete ::= | SEQUENCE { |
| rrc-TransactionIdentifier | RRC-TransactionIdentifier, |
| criticalExtensions | CHOICE { |
| rrcReconfigurationComplete | RRCReconfigurationComplete-IEs, |
| criticalExtensionsFuture | SEQUENCE { } |

}
}

| | |
|---|---|
| RRCReconfigurationComplete-IEs ::= | SEQUENCE { |
| lateNonCriticalExtension | OCTET STRING |

OPTIONAL,

| nonCritialExtension | | RRCReconfigurationComplete-v1530- |
|---|---|---|
| IEs | OPTIONAL | |

| | |
|---|---|
| } | |
| RRCReconfigurationComplete-v1530-IEs ::= | SEQUENCE { |
| uplinkTxDirectCurrentList | UplinkTxDirectCurrentList |

OPTIONAL,

| | |
|---|---|
| nonCriticalExtension | RRCReconfigurationComplete-v1560- |

| | |
|---|---|
| IEs | OPTIONAL |

}

| | |
|---|---|
| RRCReconfigurationComplete-v1560-IEs ::= | SEQUENCE { |
| scg-Response | CHOICE { |
| nr-SCG-Response | OCTET STRING (CONTAINING |

RRCReconfigurationComplete),

| | |
|---|---|
| eutra-SCG-Response | OCTET STRING |

}
OPTIONAL,

| | |
|---|---|
| nonCriticalExtension | RRCReconfigurationComplete-v1610- |

| | |
|---|---|
| IEs | OPTIONAL |

}

| | |
|---|---|
| RRCReconfigurationComplete-v1610-IEs ::= | SEQUENCE { |
| ue-MeasurementsAvailable-r16 | UE-MeasurementsAvailable-r16 |

OPTIONAL,

| | |
|---|---|
| needForGaps InfoNR-r16 | NeedForGaps InfoNR-r16 |

OPTIONAL,

| | |
|---|---|
| nonCriticalExtension | RRCReconfigurationComplete-v1640- |

| | |
|---|---|
| IEs | OPTIONAL |

}

| | |
|---|---|
| RRCReconfigurationComplete-v1640-IEs ::= | SEQUENCE { |
| uplinkTxDirectCurrentTwoCarrierList-r16 | |
| UplinkTxDirectCurrentTwoCarrierList-r16 | OPTIONAL, |
| nonCriticalExtension | RRCReconfigurationComplete-v1700- |

| | |
|---|---|
| IEs | OPTIONAL |

}

| | |
|---|---|
| RRCReconfigurationComplete-v1700-IEs ::= | SEQUENCE { |
| needForGapNCSG-InfoNR-r17 | NeedForGapNCSG-InfoNR-r17 |
| OPTIONAL, | |
| needForGapNCSG-InfoEUTRA-r17 | NeedForGapNCSG-InfoEUTRA-r17 |
| OPTIONAL, | |
| selectedCondRRCReconfig-r17 | CondReconfigId-r16 |
| OPTIONAL, | |
| nonCriticalExtension | RRCReconfigurationComplete-v1800- |

```
IEs OPTIONAL
}
RRCReconfigurationComplete-v1800-IEs ::= SEQUENCE {
  RestrictedRRCReconfiguration-IEs ENUMERATED {true, false}
OPTIONAL, -- Need M
  nonCriticalExtension SEQUENCE { }
OPTIONAL
}
-- TAG-RRCRECONFIGURATIONCOMPLETE-STOP
-- ASN1STOP
```

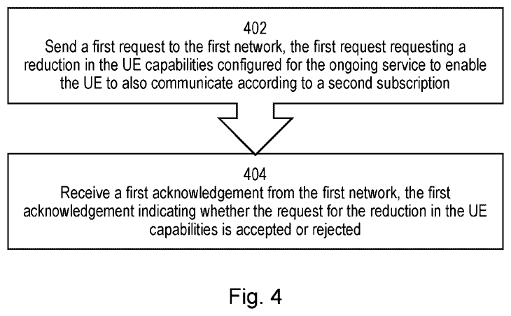

FIG. 4 illustrates a method in accordance with some embodiments.

FIG. 4 is a flow chart illustrating a method performed by a UE according to various embodiments. The UE may perform the method in response to executing suitably formulated computer readable code. The computer readable code may be embodied or stored on a computer readable medium, such as a memory chip, optical disc, or other storage medium. The computer readable medium may be part of a computer program product. The UE may be the UE 1012 or UE 1100 as described later with reference to FIGS. 10 and 11 respectively. The UE is configured to simultaneously use two or more subscriptions to communicate with one or more networks. The UE has an ongoing service with a first network according to a first subscription and the UE is configured with one or more UE capabilities for the ongoing service.

Thus, in step 402, the UE sends a first request to the first network. The first request requests a reduction in the UE capabilities configured for the ongoing service to enable the UE to also communicate according to a second subscription.

In step 404, the UE receives a first acknowledgement from the first network, the first acknowledgement indicating whether the request for the reduction in the UE capabilities is accepted or rejected.

In some embodiments, the first acknowledgement is received in a reconfiguration message for reconfiguring UE capabilities. In some embodiments, the first acknowledgement is received in a reconfiguration message that reconfigures the UE to restrict or disable one or more of the UE capabilities for the ongoing service. In some embodiments, the first acknowledgement indicates that the reconfiguration of the UE capabilities is responsive to the first request.

In some embodiments, the method further comprises the step of reconfiguring the UE capabilities according to the received reconfiguration message. After the reconfiguration, the method can further comprise communicating with the first network or a second network according to the second subscription. In some embodiments, the method can further comprise the step of sending a message to the first network or the second network indicating the UE capabilities configured for the ongoing service according to the second subscription. In some embodiments, the UE can receive a second acknowledgement from the first network or the second network, with the second acknowledgement indicating whether the configured UE capabilities are accepted or rejected.

In some embodiments, the first request is UE assistance information.

In some embodiments, the first acknowledgement is received in a RRC reconfiguration message.

The one or more UE capabilities can comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

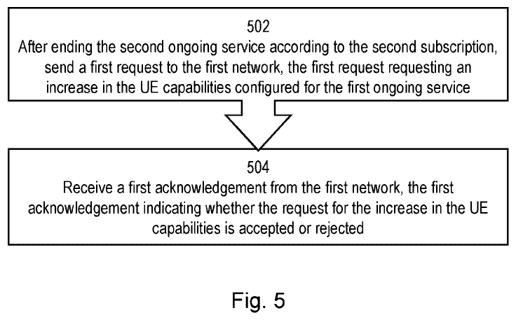

FIG. 5 is a flow chart illustrating a method performed by a UE according to various embodiments. The UE may perform the method in response to executing suitably formulated computer readable code. The computer readable code may be embodied or stored on a computer readable medium, such as a memory chip, optical disc, or other storage medium. The computer readable medium may be part of a computer program product. The UE may be the UE 1012 or UE 1100 as described later with reference to FIGS. 10 and 11 respectively. The UE is configured to simultaneously use two or more subscriptions to communicate with one or more networks. The UE has a first ongoing service with a first network according to a first subscription and a second ongoing service with the first network or a second network according to a second subscription. One or more UE capabilities of the UE are restricted or disabled to enable the UE to communicate simultaneously according to the first subscription and the second subscription.

Thus, in step 502, after ending the second ongoing service according to the second subscription, the UE sends a first request to the first network. The first request requests an increase in the UE capabilities configured for the first ongoing service.

In step 504 the UE receives a first acknowledgement from the first network. The first acknowledgement indicates whether the request for the increase in the UE capabilities is accepted or rejected.

In some embodiments, the first acknowledgement is received in a reconfiguration message for reconfiguring UE capabilities. In some embodiments, the first acknowledgement is received in a reconfiguration message that reconfigures the UE to de-restrict or enable one or more of the restricted or disabled UE capabilities. In some embodiments, the first acknowledgement indicates that the reconfiguration of the UE capabilities is responsive to the first request. In some embodiments, the method further comprises reconfiguring the UE capabilities according to the received reconfiguration message.

In some embodiments, the first request is UE assistance information.

In some embodiments, the first acknowledgement is received in a RRC reconfiguration message.

In some embodiments, the one or more restricted or disabled UE capabilities comprise one or more of: dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes. Some embodiments provide a UE that can perform both the method shown in FIG. 4, and the method shown in FIG. 5.

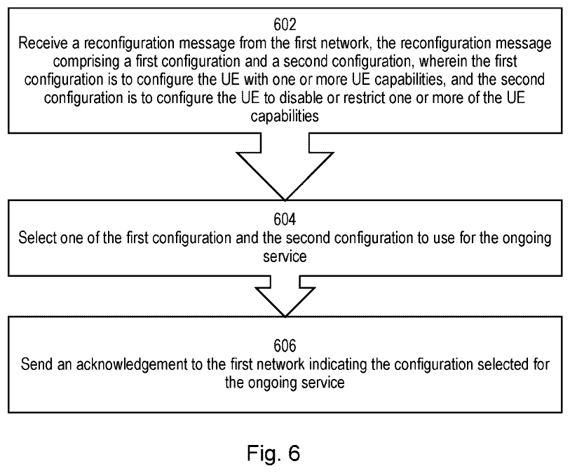

FIG. 6 is a flow chart illustrating a method performed by a UE according to various embodiments. The UE may perform the method in response to executing suitably formulated computer readable code. The computer readable code may be embodied or stored on a computer readable medium, such as a memory chip, optical disc, or other storage medium. The computer readable medium may be part of a computer program product. The UE may be the UE 1012 or UE 1100 as described later with reference to FIGS. 10 and 11 respectively. The UE is configured to simultaneously use two or more subscriptions to communicate with one or more networks. The UE has a first ongoing service with a first network according to a first subscription and the UE is configured with one or more UE capabilities for the ongoing service.

In step 602, the UE receives a reconfiguration message from the first network. The reconfiguration message comprises a first configuration and a second configuration, where the first configuration is to configure the UE with one or more UE capabilities, and the second configuration is to configure the UE to disable or restrict one or more of the UE capabilities.

In step 604, the UE selects one of the first configuration and the second configuration to use for the ongoing service.

In step 606, the UE sends an acknowledgement to the first network indicating the configuration selected for the ongoing service.

In some embodiments, the acknowledgement is sent in a reconfiguration complete message. In some embodiments, the acknowledgement is sent in a Radio Resource Control, RRC, reconfiguration complete message.

In some embodiments, the method further comprises reconfiguring the UE capabilities according to the selected configuration.

In some embodiments, the one or more UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

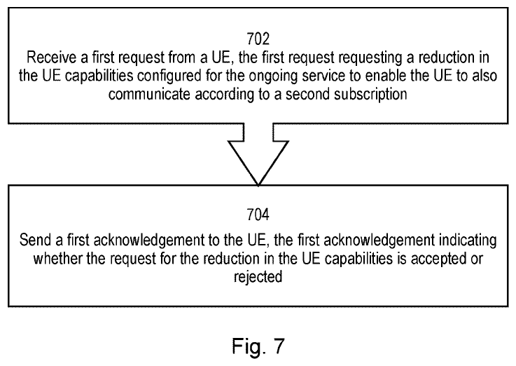

FIG. 7 is a flow chart illustrating a method performed by a RAN node in a first network according to various embodiments. The RAN node may perform the method in response to executing suitably formulated computer readable code. The computer readable code may be embodied or stored on a computer readable medium, such as a memory chip, optical disc, or other storage medium. The computer readable medium may be part of a computer program product. The RAN node may be the network node 1010 or network node 1200 as described later with reference to FIGS. 10 and 12 respectively.

In step 702, the RAN node receives a first request from a UE. The UE is configured to simultaneously use two or more subscriptions to communicate with one or more networks. The UE has an ongoing service with the first network according to a first subscription and the UE is configured with one or more UE capabilities for the ongoing service. The first request received in step 702 requests a reduction in the UE capabilities configured for the ongoing service to enable the UE to also communicate according to a second subscription.

In step 704, the RAN node sends a first acknowledgement to the UE, the first acknowledgement indicating whether the request for the reduction in the UE capabilities is accepted or rejected.

In some embodiments, the first acknowledgement is sent in a reconfiguration message for reconfiguring UE capabilities. In some embodiments, the first acknowledgement is sent in a reconfiguration message that reconfigures the UE to restrict or disable one or more of the UE capabilities for the ongoing service.

In some embodiments, the first acknowledgement indicates that the reconfiguration of the UE capabilities is responsive to the first request.

In some embodiments, the method further comprises the step of reconfiguring the UE capabilities according to the sent reconfiguration message.

In some embodiments, after the reconfiguration, the method can further comprise communicating with the UE according to the second subscription. This can be the case where the second subscription is also with the first network, with the same or different operator to the first subscription. In some embodiments, the method can further comprise the step of receiving a message from the UE indicating the UE capabilities configured for the ongoing service according to the second subscription. In some embodiments, the UE can send a second acknowledgement to the UE. The second acknowledgement indicates whether the configured UE capabilities are accepted or rejected.

In some embodiments, the first request is UE assistance information.

In some embodiments, the first acknowledgement is sent in a RRC reconfiguration message.

The one or more UE capabilities can comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

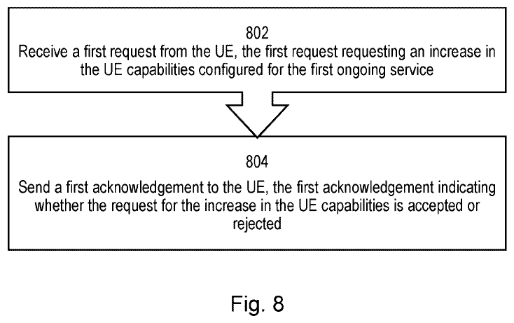

FIG. 8 is a flow chart illustrating a method performed by a RAN node in a first network according to various embodiments. The RAN node may perform the method in response to executing suitably formulated computer readable code. The computer readable code may be embodied or stored on a computer readable medium, such as a memory chip, optical disc, or other storage medium. The computer readable medium may be part of a computer program product. The RAN node may be the network node 1010 or network node 1200 as described later with reference to FIGS. 10 and 12 respectively.

In step 802, the RAN node receives a first request from a UE. The UE has a first ongoing service with a first network according to a first subscription and a second ongoing service with the first network or a second network according to a second subscription. The UE is configured with one or more UE capabilities for the ongoing services, and one or more UE capabilities of the UE are restricted or disabled to enable the UE to communicate simultaneously according to the first subscription and the second subscription. The first request received in step 802 requests an increase in the UE capabilities configured for the first ongoing service.

In step 804 the RAN node sends a first acknowledgement to the UE. The first acknowledgement indicates whether the request for the increase in the UE capabilities is accepted or rejected.

In some embodiments, the first acknowledgement is sent in a reconfiguration message for reconfiguring UE capabilities. In some embodiments, the first acknowledgement is sent in a reconfiguration message that reconfigures the UE to de-restrict or enable one or more of the restricted or disabled UE capabilities. In some embodiments, the first acknowledgement indicates that the reconfiguration of the UE capabilities is responsive to the first request.

In some embodiments, the first request is UE assistance information.

In some embodiments, the first acknowledgement is sent in a RRC reconfiguration message.

In some embodiments, the one or more restricted or disabled UE capabilities comprise one or more of: dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes. Some embodiments provide a RAN node that can perform both the method shown in FIG. 7, and the method shown in FIG. 8.

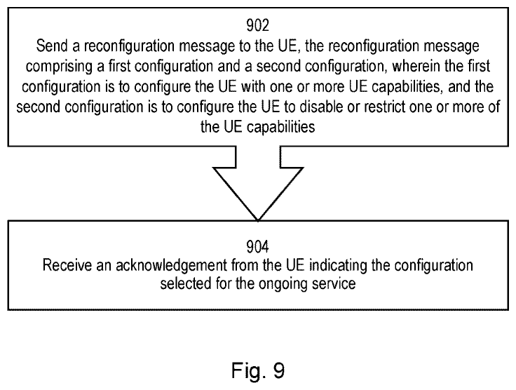

FIG. 9 is a flow chart illustrating a method performed by a RAN node in a first network according to various embodiments. The RAN node may perform the method in response to executing suitably formulated computer readable code. The computer readable code may be embodied or stored on a computer readable medium, such as a memory chip, optical disc, or other storage medium. The computer readable medium may be part of a computer program product. The RAN node may be the network node 1010 or network node 1200 as described later with reference to FIGS. 10 and 12 respectively.

In step 902, the RAN node sends a reconfiguration message to a UE. The UE has a first ongoing service with the first network according to a first subscription and the UE is configured with one or more UE capabilities for the ongoing service. The reconfiguration message sent in step 902 comprises a first configuration and a second configuration. The first configuration is to configure the UE with one or more UE capabilities, and the second configuration is to configure the UE to disable or restrict one or more of the UE capabilities.

In step 904, the RAN node receives an acknowledgement from the UE indicating the configuration selected for the ongoing service.

In some embodiments, the acknowledgement is received in a reconfiguration complete message. In some embodiments, the acknowledgement is received in a Radio Resource Control, RRC, reconfiguration complete message.

In some embodiments, the one or more UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 10, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, a content source and analytics node, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs). The processing circuitry 1102 may be operable to provide, either alone or in conjunction with other UE 1100 components, such as the memory 1110, UE 1100 functionality. For example, the processing circuitry 1102 may be configured to cause the UE 1102 to perform the methods as described with reference to FIG. 2, FIG. 4, FIG. 5 or FIG. 6.

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In some embodiments, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both The speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (Aps) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes 45 processing circuitry 1202, a memory 1204, a communication interface 1206, and a power source 1208, and/or any other component, or any combination thereof. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, network node 1200 functionality. For example, the processing circuitry 1202 may be configured to cause the network node to perform the methods as described with reference to FIG. 3, FIG. 7, FIG. 8 or FIG. 9.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

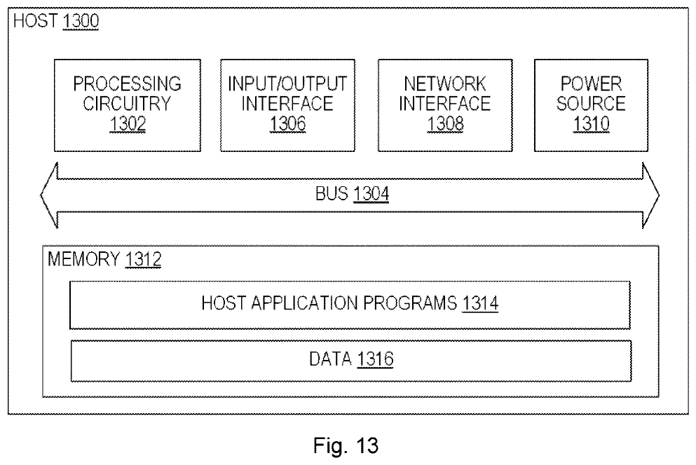

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

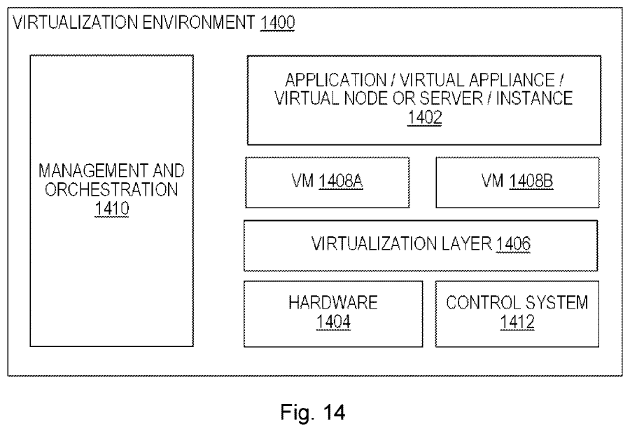

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

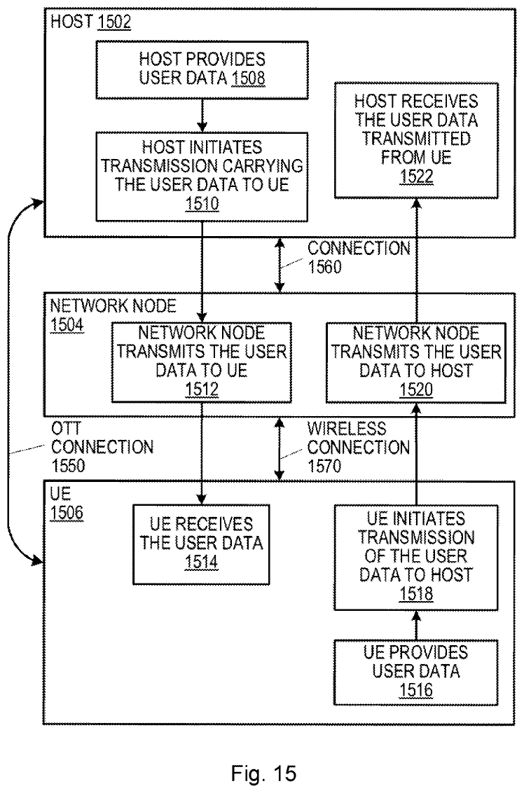

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506.

The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve the configurations of the UE and thereby provide benefits such as improved UE performance.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

1. A method performed by a user equipment that is configured to simultaneously use two or more subscriptions to communicate with one or more networks, wherein the UE has an ongoing first service with a first network according to a first subscription:
   establishing or resuming a second service with a second network according to a second subscription; and
   indicating to the second network that the user equipment has restricted capabilities for the second service.
2. The method of embodiment 1 further comprising:
   transmitting an indication of first capabilities that are supported in the second service or an indication of second capabilities that are restricted in the second service.
3. The method of embodiment 1 or 2 wherein the step of indicating to the second network that the user equipment has restricted capabilities for the second service comprises:
   transmitting a 1-bit notification to the second network indicating that that the user equipment has restricted capabilities for the second service.
4. The method of embodiment 3 wherein the 1-bit notification is transmitted in one of: an RRCSetupRequest message, an RRCResumeRequest message, RRCSetupComplete message, an RRCResumeComplete message or an RRCReconfigurationComplete message.
5. The method of embodiment 1 or 2 wherein the step of indicating comprises:
   transmitting an information element to the second network indicating that that the user equipment has restricted capabilities for the second service.
6. The method of embodiment 5 wherein the information element is transmitted in one of: RRCSetupComplete message, an RRCResumeComplete message or an RRCReconfigurationComplete message.
7. The method of embodiment 6 wherein the information element indicates that one or more types of capabilities are restricted.
8. The method of embodiment 4 when dependent on embodiment 2 further comprising:
   responsive to transmitting the 1-bit notification in an RRCSetupRequest message or an RRCResumeRequest message, transmitting, in a message, the indication of first capabilities that are supported in the second service or the indication of second capabilities that are not supported in the second service.
9. The method of embodiment 8 wherein the message comprises one of: an RRCSetupComplete message or an RRCResumeComplete message.
10. The method of embodiment 2 wherein the first capabilities that are supported in the second service are transmitted in a UECapabilityInformation message.
11. The method of embodiment 10 further comprising transmitting the indication of the first capabilities in response to receiving a UECapabilityEnquiry message from the second network.
12. The method of embodiment 10 or 11 wherein the indication of the first capabilities comprises an indication that the first capabilities are a subset of a set of normal UE capabilities in the UECapabilityInformation message.
13. The method of embodiment 10 or 11 wherein the indication of the first capabilities comprises an indication of whether each of a set of normal UE capabilities is in the first capabilities.
14. The method of embodiment 2 wherein the first capabilities that are supported in the second service are transmitted in a UEAssistanceInformation message.
15. The method of any one of embodiments 5 to 7 when dependent on embodiment 2 further comprising:
   transmitting the indication of the first capabilities or the indication of the second capabilities responsive to receiving a request to report first capabilities or second capabilities.
16. The method of embodiment 15 wherein the request to report first capabilities or second capabilities is received in a UEInformationRequest.
17. The method of embodiment 16 wherein the indication of the first capabilities or the indication of the second capabilities is transmitted in a UEInformationResponse message.
18. The method of any previous embodiment when dependent on embodiment 2, wherein the indication of second capabilities that are restricted in the second service comprises one or more of:
   a maximum aggregated bandwidth across all downlink and uplink carrier(s) of a first frequency range, FR1, and/or a second frequency range, FR2;
      a maximum number of downlink and uplink secondary cells in a master cell group and/or a maximum number of downlink and uplink primary cells and secondary cells in a secondary cell group for a first frequency range, FR1 and/or a second frequency range, FR2;
   a maximum number of receiving, Rx, chains or panels for a second frequency range, FR2;
   a list of carrier frequencies and/or carrier frequency combinations that need to be released
   a list of band combinations on whether measurement gap/NCSG is needed for a target NR/E-UTRA band that need to be updated;
   one or more restricted UE power classes for operation in the second network;
   a restricted maximum uplink duty cycle, MUDC;
   a restricted MIMO configuration for the UE operation in the second network;
   restricted receiving, Rx, chains and/or panels for the UE operation in the second network;
   a restricted UE receiver configuration for the UE operation the second network;
   a restricted duplex mode, DM, for the UE operation in the second network;
   restricted processing capability for the UE operation in the second network;
   restricted sidelink (SL) operation in the second network when the UE operates in the second network;
   restricted operation of Ultra-Reliable and Low Latency Communications (URLLC) in the second network when the UE operates in the second network;
   a restricted measurement capability for the UE operation in the second network for NeedForGaps and/or NCSG (Network Controlled Small Gap) capability; and
   restricted enhanced measurement capabilities for the UE operation in the second network, such as NeedForGaps and/or NCSG capability.
19. A method of embodiment 18 further comprising:
   indicating timing information related to or associated with the second capabilities that are restricted in the second service.
20. The method of embodiment 19 wherein the timing information is associated with all of the second capabilities.
21. The method of embodiment 19 wherein the timing information is associated with a subset of the second capabilities.
22. The method of any previous embodiment wherein the first network is the same as the second network.
23. The method of any of the previous embodiments, further comprising:
   providing user data; and
   forwarding the user data to a host via the transmission to the network node.

### Group B Embodiments

24. A method performed by a network node in a second network for communicating with a user equipment, UE, that is configured to simultaneously use two or more subscriptions to communicate with one or more networks, wherein the UE has an ongoing first service with a first network according to a first subscription, the method comprising:
   establishing or resuming a second service with the UE according to a second subscription; and
   receiving an indication from the UE that the UE has restricted capabilities for the second service.
25. The method of embodiment 24 further comprising:
   receiving an indication of first capabilities that are supported in the second service or an indication of second capabilities that are restricted in the second service.
26. The method of embodiment 24 or 25 wherein the step of receiving an indication that the UE has restricted capabilities for the second service comprises:
   receiving a 1-bit notification from the UE indicating that that the UE has restricted capabilities for the second service.
27. The method of embodiment 26 wherein the 1-bit notification is received in one of: an RRCSetupRequest message, an RRCResumeRequest message, RRCSetupComplete message, an RRCResumeComplete message or an RRCReconfigurationComplete message.
28. The method of embodiment 24 or 25 wherein the step of receiving an indication that the UE has restricted capabilities for the second service comprises:
   receiving an information element from the UE indicating that that the UE has restricted capabilities for the second service.
29. The method of embodiment 28 wherein the information element is received in one of: RRCSetupComplete message, an RRCResumeComplete message or an
RRCReconfigurationComplete message.
30. The method of embodiment 29 wherein the information element indicates that one or more types of capabilities are restricted.
31. The method of embodiment 27 or 28 when dependent on embodiment 26 further comprising:
   responsive to receiving the 1-bit notification in an RRCSetupRequest message or an RRCResumeRequest message, receiving, in a message, the indication of first capabilities that are supported in the second service or the indication of second capabilities that are not supported in the second service.
32. The method of embodiment 31 wherein the message comprises one of: an RRCSetupComplete message or an RRCResumeComplete message.
33. The method of embodiment 26 to 29 further comprising:
   responsive to receiving the indication that the UE has restricted capabilities, configuring the UE with a basic configuration.
34. The method of embodiment 25 wherein the first capabilities that are supported in the second service are received in a UECapabilityInformation message.
35. The method of embodiment 34 further comprising receiving the indication of the first capabilities in response to transmitting a UECapabilityEnquiry message to the UE.
36. The method of embodiment 34 or 35 wherein the indication of the first capabilities comprises an indication that the first capabilities are a subset of a set of normal UE capabilities in the UECapabilityInformation message.
37. The method of embodiment 34 or 35 wherein the indication of the first capabilities comprises an indication of whether each of a set of normal UE capabilities is in the first capabilities.
38. The method of embodiment 25 wherein the first capabilities that are supported in the second service are received in a UEAssistanceInformation message.
39. The method of embodiment 38 further comprising configuring the UE to report the first capabilities in a UEAssistanceInformation message.
40. The method of any one of embodiments 28 to 30 when dependent on embodiment 25 further comprising:
   receiving the indication of the first capabilities or the indication of the second capabilities responsive to transmitting a request to report first capabilities or second capabilities.
41. The method of embodiment 40 wherein the request to report first capabilities or second capabilities is transmitted in a UEInformationRequest.
42. The method of embodiment 41 wherein the indication of the first capabilities or the indication of the second capabilities is received in a UEInformationResponse message.
43. The method of any previous embodiment when dependent on embodiment 25, wherein the indication of second capabilities that are restricted in the second service comprises one or more of:
   a maximum aggregated bandwidth across all downlink and uplink carrier(s) of a first frequency range, FR1, and/or a second frequency range, FR2;
      a maximum number of downlink and uplink secondary cells in a master cell group and/or a maximum number of downlink and uplink primary cells and secondary cells in a secondary cell group for a first frequency range, FR1 and/or a second frequency range, FR2;
   a maximum number of receiving, Rx, chains or panels for a second frequency range, FR2;
   a list of carrier frequencies and/or carrier frequency combinations that need to be released
   a list of band combinations on whether measurement gap/NCSG is needed for a target NR/E-UTRA band that need to be updated;
   one or more restricted UE power classes for operation in the second network;
   a restricted maximum uplink duty cycle, MUDC;
   a restricted MIMO configuration for the UE operation in the second network;
   restricted receiving, Rx, chains and/or panels for the UE operation in the second network;
   a restricted UE receiver configuration for the UE operation the second network;
   a restricted duplex mode, DM, for the UE operation in the second network;
   restricted processing capability for the UE operation in the second network;
   restricted sidelink (SL) operation in the second network when the UE operates in the second network;
   restricted operation of Ultra-Reliable and Low Latency Communications (URLLC) in the second network when the UE operates in the second network;
   a restricted measurement capability for the UE operation in the second network for NeedForGaps and/or NCSG (Network Controlled Small Gap) capability; and
   restricted enhanced measurement capabilities for the UE operation in the second network, such as NeedForGaps and/or NCSG capability.
44. A method of embodiment 43 further comprising:
   receiving timing information related to or associated with the second capabilities that are restricted in the second service.
45. The method of embodiment 44 wherein the timing information is associated with all of the second capabilities.
46. The method of embodiment 44 wherein the timing information is associated with a subset of the second capabilities.
47. The method of any previous embodiment when dependent on embodiment 25 further comprising:
   reconfiguring the UE based on the first capabilities or the second capabilities.
48. The method of embodiment 47 when dependent on one of embodiments 44 to 46 wherein the step of reconfiguring the UE based on the first capabilities or the second capabilities comprises reconfiguring the UE for a time period indicated by the timing information.
49. The method of any one of embodiments 24 to 38 further comprising:
   notifying a second node in the second network that the UE capabilities are restricted.
50. The method of any one of embodiments 24 to 49 wherein the first network is the same as the second network.
51. The method of any of the previous embodiments, further comprising:
   obtaining user data; and
   forwarding the user data to a host or a user equipment.

### Group C Embodiments

52. A user equipment, UE, that is configured to simultaneously use two or more subscriptions to communicate with one or more networks, wherein the UE has an ongoing first service with a first network according to a first subscription, comprising:
   processing circuitry configured to cause the user equipment to perform any of the steps of any of the Group A embodiments; and
   power supply circuitry configured to supply power to the processing circuitry.
53. A network node for communicating with a user equipment, UE, that is configured to simultaneously use two or more subscriptions to communicate with one or more networks, wherein the UE has an ongoing first service with a first network according to a first subscription, the network node comprising:
   processing circuitry configured to cause the network node to perform any of the steps of any of the Group B embodiments;
   power supply circuitry configured to supply power to the processing circuitry.
54. A user equipment (UE) that is configured to simultaneously use two or more subscriptions to communicate with one or more networks, wherein the UE has an ongoing first service with a first network according to a first subscription, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
55. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
56. The host of the previous embodiment, wherein the cellular network further includes a network node configured to communicate with the UE to transmit the user data to the UE from the host.
57. The host of the previous 2 embodiments, wherein:
   the processing circuitry of the host is configured to execute a host application, thereby providing the user data; and
   the host application is configured to interact with a client application executing on the UE, the client application being associated with the host application.
58. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
59. The method of the previous embodiment, further comprising:
   at the host, executing a host application associated with a client application executing on the UE to receive the user data from the UE.
60. The method of the previous embodiment, further comprising:
   at the host, transmitting input data to the client application executing on the UE, the input data being provided by executing the host application,
   wherein the user data is provided by the client application in response to the input data from the host application.
61. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
62. The host of the previous embodiment, wherein the cellular network further includes a network node configured to communicate with the UE to transmit the user data from the UE to the host.
63. The host of the previous 2 embodiments, wherein:
   the processing circuitry of the host is configured to execute a host application, thereby providing the user data; and
   the host application is configured to interact with a client application executing on the UE, the client application being associated with the host application.
64. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.
65. The method of the previous embodiment, further comprising:
   at the host, executing a host application associated with a client application executing on the UE to receive the user data from the UE.
66. The method of the previous embodiment, further comprising:
   at the host, transmitting input data to the client application executing on the UE, the input data being provided by executing the host application,
   wherein the user data is provided by the client application in response to the input data from the host application.
67. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
68. The host of the previous embodiment, wherein:
   the processing circuitry of the host is configured to execute a host application that provides the user data; and
   the UE comprises processing circuitry configured to execute a client application associated with the host application to receive the transmission of user data from the host.
69. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
70. The method of the previous embodiment, further comprising, at the network node, transmitting the user data provided by the host for the UE.
71. The method of any of the previous 2 embodiments, wherein the user data is provided at the host by executing a host application that interacts with a client application executing on the UE, the client application being associated with the host application.
72. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
73. The communication system of the previous embodiment, further comprising:
   the network node; and/or
   the user equipment.
74. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
75. The host of the previous embodiment, wherein:
   the processing circuitry of the host is configured to execute a host application, thereby providing the user data; and
   the host application is configured to interact with a client application executing on the UE, the client application being associated with the host application.
76. The host of the any of the previous 2 embodiments, wherein the initiating receipt of the user data comprises requesting the user data.
77. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
78. The method of the previous embodiment, further comprising at the network node, transmitting the received user data to the host.

### EMBODIMENTS

### Group A Embodiments

1. A method performed by a user equipment, UE, that is configured to simultaneously use two or more subscriptions to communicate with one or more networks, wherein the UE has an ongoing service with a first network according to a first subscription and the UE is configured with one or more UE capabilities for the ongoing service, the method comprising:
sending a first request to the first network, the first request requesting a reduction in the UE capabilities configured for the ongoing service to enable the UE to also communicate according to a second subscription; and
receiving a first acknowledgement from the first network, the first acknowledgement indicating whether the request for the reduction in the UE capabilities is accepted or rejected.

2. The method of Embodiment 1, wherein the first acknowledgement is received in a reconfiguration message for reconfiguring UE capabilities.

3. The method of Embodiment 1 or 2, wherein the first acknowledgement is received in a reconfiguration message that reconfigures the UE to restrict or disable one or more of the UE capabilities for the ongoing service.

4. The method of Embodiment 3, wherein the first acknowledgement indicates that the reconfiguration of the UE capabilities is responsive to the first request.

5. The method of Embodiment 2, 3 or 4, further comprising the step of:
reconfiguring the UE capabilities according to the received reconfiguration message.

6. The method of Embodiment 5, further comprising the step of:
communicating with the first network or a second network according to the second subscription.

7. The method of Embodiment 6, further comprising the step of:
sending a message to the first network or the second network indicating the UE capabilities configured for the ongoing service according to the second subscription.

8. The method of Embodiment 7, further comprising the step of:
receiving a second acknowledgement from the first network or the second network, the second acknowledgement indicating whether the configured UE capabilities are accepted or rejected.

9. The method of any of Embodiments 1-8, wherein the first request is UE assistance information.

10. The method of any of Embodiments 1-9, wherein the first acknowledgement is received in a Radio Resource Control, RRC, reconfiguration message.

11. The method of any of Embodiments 1-10, wherein the one or more UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

12. A method performed by a user equipment, UE, that is configured to simultaneously use two or more subscriptions to communicate with one or more networks, wherein the UE has a first ongoing service with a first network according to a first subscription and a second ongoing service with the first network or a second network according to a second subscription, and wherein one or more UE capabilities of the UE are restricted or disabled to enable the UE to communicate simultaneously according to the first subscription and the second subscription, the method comprising:
after ending the second ongoing service according to the second subscription, sending a first request to the first network, the first request requesting an increase in the UE capabilities configured for the first ongoing service; and
receiving a first acknowledgement from the first network, the first acknowledgement indicating whether the request for the increase in the UE capabilities is accepted or rejected.

13. The method of Embodiment 12, wherein the first acknowledgement is received in a reconfiguration message for reconfiguring UE capabilities.

14. The method of Embodiment 12 or 13, wherein the first acknowledgement is received in a reconfiguration message that reconfigures the UE to de-restrict or enable one or more of the restricted or disabled UE capabilities.

15. The method of any of Embodiments 12-14, wherein the first acknowledgement indicates that the reconfiguration of the UE capabilities is responsive to the first request.

16. The method of any of Embodiments 12-15, further comprising the step of:
reconfiguring the UE capabilities according to the received reconfiguration message.

17. The method of any of Embodiments 12-16, wherein the first request is UE assistance information.

18. The method of any of Embodiments 12-17, wherein the first acknowledgement is received in a Radio Resource Control, RRC, reconfiguration message.

19. The method of any of Embodiments 12-18, wherein the one or more restricted or disabled UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

20. A method performed by a user equipment, UE, that is configured to simultaneously use two or more subscriptions to communicate with one or more networks, the method comprising:
performing the method according to any of embodiments 1-11 to enable the UE to also communicate according to a second subscription; and
performing the method according to any of embodiments 12-19 after ending an ongoing service according to the second subscription.

21. A method performed by a user equipment, UE, that is configured to simultaneously use two or more subscriptions to communicate with one or more networks, wherein the UE has an ongoing service with a first network according to a first subscription and the UE is configured with one or more UE capabilities for the ongoing service, the method comprising:
receiving a reconfiguration message from the first network, the reconfiguration message comprising a first configuration and a second configuration, wherein the first configuration is to configure the UE with one or more UE capabilities, and the second configuration is to configure the UE to disable or restrict one or more of the UE capabilities;
selecting one of the first configuration and the second configuration to use for the ongoing service; and
service. sending an acknowledgement to the first network indicating the configuration selected for the ongoing

22. The method of Embodiment 21, wherein the acknowledgement is sent in a reconfiguration complete message.

23. The method of Embodiment 22, wherein the acknowledgement is sent in a Radio Resource Control, RRC, reconfiguration complete message.

24. The method of Embodiment 21, 22 or 23, further comprising the step of:
reconfiguring the UE capabilities according to the selected configuration.

25. The method of any of Embodiments 21-24, wherein the one or more UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

### Group B Embodiments

26. A method performed by a radio access network, RAN, node in a first network, wherein a user equipment, UE, has an ongoing service with the first network according to a first subscription and the UE is configured with one or more UE capabilities for the ongoing service, the method comprising:
receiving a first request from the UE, the first request requesting a reduction in UE capabilities configured for the ongoing service to enable the UE to also communicate according to a second subscription; and
sending a first acknowledgement to the UE, the first acknowledgement indicating whether the request for the reduction in the UE capabilities is accepted or rejected.

27. The method of Embodiment 26, wherein the first acknowledgement is sent in a reconfiguration message for reconfiguring UE capabilities.

28. The method of Embodiment 26 or 27, wherein the first acknowledgement is sent in a reconfiguration message that reconfigures the UE to restrict or disable one or more of the UE capabilities for the ongoing service.

29. The method of Embodiment 28, wherein the first acknowledgement indicates that the reconfiguration of the UE capabilities is responsive to the first request.

30. The method of Embodiment 28 or 29, further comprising the step of:
reconfiguring the UE capabilities according to the sent reconfiguration message.

31. The method of Embodiment 30, further comprising the step of:
communicating with the UE according to a second subscription.

32. The method of Embodiment 31, further comprising the step of:
receiving a message from the UE indicating the UE capabilities configured for the communications according to the second subscription.

33. The method of Embodiment 32, further comprising the step of:
sending a second acknowledgement to the UE, the second acknowledgement indicating whether the configured UE capabilities are accepted or rejected.

34. The method of any of Embodiments 26-33, wherein the first request is UE assistance information.

35. The method of any of Embodiments 26-34, wherein the first acknowledgement is sent in a Radio Resource Control, RRC, reconfiguration message.

36. The method of any of Embodiments 26-35, wherein the one or more UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

37. A method performed by a radio access network, RAN, node in a first network, wherein a user equipment, UE, has a first ongoing service with the first network according to a first subscription and a second ongoing service with the first network or a second network according to a second subscription, and the UE is configured with one or more UE capabilities for the ongoing services, wherein one or more UE capabilities of the UE are restricted or disabled to enable the UE to communicate simultaneously according to the first subscription and the second subscription, the method comprising:
receiving a first request from the UE, the first request requesting an increase in the UE capabilities configured for the first ongoing service; and
sending a first acknowledgement to the UE, the first acknowledgement indicating whether the request for the increase in the UE capabilities is accepted or rejected.

38. The method of Embodiment 37, wherein the first acknowledgement is sent in a reconfiguration message for reconfiguring UE capabilities.

39. The method of Embodiment 37 or 38, wherein the first acknowledgement is sent in a reconfiguration message that reconfigures the UE to de-restrict or enable one or more of the restricted or disabled UE capabilities.

40. The method of any of Embodiments 37-39, wherein the first acknowledgement indicates that the reconfiguration of the UE capabilities is responsive to the first request.

41. The method of any of Embodiments 37-40, wherein the first request is UE assistance information.

42. The method of any of Embodiments 37-41, wherein the first acknowledgement is sent in a Radio Resource Control, RRC, reconfiguration message.

43. The method of any of Embodiments 37-42, wherein the one or more restricted or disabled UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

44. A method performed by a radio access network, RAN, node in a first network, wherein a user equipment, UE, has an ongoing service with the first network according to a first subscription and the UE is configured with one or more UE capabilities for the ongoing service, the method comprising:
performing the method according to any of embodiments 26-35 to enable the UE to also communicate according to a second subscription; and
performing the method according to any of embodiments 37-43 after the UE ends an ongoing service according to the second subscription.

45. A method performed by a radio access network, RAN, node in a first network, wherein a user equipment, UE, has an ongoing service with the first network according to a first subscription and the UE is configured with one or more UE capabilities for the ongoing service, the method comprising:
sending a reconfiguration message to the UE, the reconfiguration message comprising a first configuration and a second configuration, wherein the first configuration is to configure the UE with one or more UE capabilities, and the second configuration is to configure the UE to disable or restrict one or more of the UE capabilities; and
receiving an acknowledgement from the UE indicating the configuration selected for the ongoing service.

46. The method of Embodiment 45, wherein the acknowledgement is received in a reconfiguration complete message.

47. The method of Embodiment 46, wherein the acknowledgement is received in a Radio Resource Control, RRC, reconfiguration complete message.

48. The method of any of Embodiments 45-47, wherein the one or more UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

### Group C Embodiments

49. A computer program product comprising a computer readable medium having computer readable code embodied therein, the computer readable code being configured such that, on execution by a suitable computer or processor, the computer or processor is caused to perform the method of any of the Group A embodiments or the Group B embodiments.

50. A user equipment, UE, configured to perform the method of any of the Group A embodiments.

51. A user equipment, UE, comprising a processor and a memory, said memory containing instructions executable by said processor whereby said UE is operative to perform the method of any of the Group A embodiments.

52. A radio access network, RAN, node, configured to perform the method of any of the Group B embodiments.

53. A radio access network, RAN, node comprising a processor and a memory, said memory containing instructions executable by said processor whereby said RAN node is operative to perform the method of any of the Group B embodiments.

54. A user equipment, comprising:
processing circuitry configured to cause the user equipment to perform any of the steps of any of the Group A embodiments; and
power supply circuitry configured to supply power to the processing circuitry.

55. A network node, the network node comprising:
processing circuitry configured to cause the network node to perform any of the steps of any of the Group B embodiments; and
power supply circuitry configured to supply power to the processing circuitry.

56. A user equipment (UE), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

### REFERENCES

1. RP-210316, WID: Support for Multi-SIM devices for LTE/NR
2. RP-220955, WID: Dual Transmission/Reception (Tx/Rx) Multi-SIM for NR

### Abbreviations

At least some of the following abbreviations may be used in this disclosure. If there is an inconsistency between abbreviations, preference should be given to how it is used above. If listed multiple times below, the first listing should be preferred over any subsequent listing(s).
BW Bandwidth
CA Carrier Aggregation
CC Component Carrier
CE Control Element
DC Dual Connectivity
DCI Downlink Control Information
HARQ Hybrid automatic repeat request
MAC Medium Access Control
MCG Master Cell Group
MIMO Multiple Input, Multiple Output
MUDC Maximum Uplink Duty Cycle
MUSIM Multi-USIM
NCSG Network Controlled Small Gap
NW Network
NPN Non-Public Network
PC Power Class
PDSCH Physical downlink shared channel
PUCCH Physical uplink control channel
PLMN Public Land Mobile Network
Rx Receiver
SAR Specific Absorption Rate
SCG Secondary Cell Group
Tx Transmitter
UE User Equipment (Wireless device in 3GPP systems)
URLLC Ultra-Reliable and Low Latency Communications
USIM Universal Subscriber Identity Module
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

### EMBODIMENTS

### Group A Embodiments

1. A method performed by a user equipment that is configured to simultaneously use two or more subscriptions to communicate with one or more networks, wherein the UE has an ongoing first service with a first network according to a first subscription:
establishing or resuming a second service with a second network according to a second subscription; and
indicating to the second network that the user equipment has restricted capabilities for the second service.

2. The method of embodiment 1 further comprising:
transmitting an indication of first capabilities that are supported in the second service or an indication of second capabilities that are restricted in the second service.

3. The method of embodiment 1 or 2 wherein the step of indicating to the second network that the user equipment has restricted capabilities for the second service comprises:
transmitting a 1-bit notification to the second network indicating that that the user equipment has restricted capabilities for the second service.

4. The method of embodiment 3 wherein the 1-bit notification is transmitted in one of: an RRCSetupRequest message, an RRCResumeRequest message, RRCSetupComplete message, an RRCResumeComplete message or an RRCReconfigurationComplete message.

5. The method of embodiment 1 or 2 wherein the step of indicating comprises:
transmitting an information element to the second network indicating that that the user equipment has restricted capabilities for the second service.

6. The method of embodiment 5 wherein the information element is transmitted in one of: RRCSetupComplete message, an RRCResumeComplete message or an RRCReconfigurationComplete message.

7. The method of embodiment 6 wherein the information element indicates that one or more types of capabilities are restricted.

8. The method of embodiment 4 when dependent on embodiment 2 further comprising:
responsive to transmitting the 1-bit notification in an RRCSetupRequest message or an RRCResumeRequest message, transmitting, in a message, the indication of first capabilities that are supported in the second service or the indication of second capabilities that are not supported in the second service.

9. The method of embodiment 8 wherein the message comprises one of: an RRCSetupComplete message or an RRCResumeComplete message.

10. The method of embodiment 2 wherein the first capabilities that are supported in the second service are transmitted in a UECapabilityInformation message.

11. The method of embodiment 10 further comprising transmitting the indication of the first capabilities in response to receiving a UECapabilityEnquiry message from the second network.

12. The method of embodiment 10 or 11 wherein the indication of the first capabilities comprises an indication that the first capabilities are a subset of a set of normal UE capabilities in the UECapabilityInformation message.

13. The method of embodiment 10 or 11 wherein the indication of the first capabilities comprises an indication of whether each of a set of normal UE capabilities is in the first capabilities.

14. The method of embodiment 2 wherein the first capabilities that are supported in the second service are transmitted in a UEAssistanceInformation message.

15. The method of any one of embodiments 5 to 7 when dependent on embodiment 2 further comprising:
transmitting the indication of the first capabilities or the indication of the second capabilities responsive to receiving a request to report first capabilities or second capabilities.

16. The method of embodiment 15 wherein the request to report first capabilities or second capabilities is received in a UEInformationRequest.

17. The method of embodiment 16 wherein the indication of the first capabilities or the indication of the second capabilities is transmitted in a UEInformationResponse message.

18. The method of any previous embodiment when dependent on embodiment 2, wherein the indication of second capabilities that are restricted in the second service comprises one or more of:
a maximum aggregated bandwidth across all downlink and uplink carrier(s) of a first frequency range, FR1, and/or a second frequency range, FR2;
   a maximum number of downlink and uplink secondary cells in a master cell group and/or a maximum number of downlink and uplink primary cells and secondary cells in a secondary cell group for a first frequency range, FR1 and/or a second frequency range, FR2;
a maximum number of receiving, Rx, chains or panels for a second frequency range, FR2;
a list of carrier frequencies and/or carrier frequency combinations that need to be released
a list of band combinations on whether measurement gap/NCSG is needed for a target NR/E-UTRA band that need to be updated;
one or more restricted UE power classes for operation in the second network;
a restricted maximum uplink duty cycle, MUDC;
a restricted MIMO configuration for the UE operation in the second network;
restricted receiving, Rx, chains and/or panels for the UE operation in the second network;
a restricted UE receiver configuration for the UE operation the second network;
a restricted duplex mode, DM, for the UE operation in the second network;
restricted processing capability for the UE operation in the second network;
restricted sidelink (SL) operation in the second network when the UE operates in the second network;
restricted operation of Ultra-Reliable and Low Latency Communications (URLLC) in the second network when the UE operates in the second network;
a restricted measurement capability for the UE operation in the second network for NeedForGaps and/or NCSG (Network Controlled Small Gap) capability; and
restricted enhanced measurement capabilities for the UE operation in the second network, such as NeedForGaps and/or NCSG capability.

19. A method of embodiment 18 further comprising:
indicating timing information related to or associated with the second capabilities that are restricted in the second service.

20. The method of embodiment 19 wherein the timing information is associated with all of the second capabilities.

21. The method of embodiment 19 wherein the timing information is associated with a subset of the second capabilities.

22. The method of any previous embodiment wherein the first network is the same as the second network.

23. The method of any of the previous embodiments, further comprising:
providing user data; and
forwarding the user data to a host via the transmission to the network node.

24. A method performed by a user equipment, UE, that is configured to simultaneously use two or more subscriptions to communicate with one or more networks, wherein the UE has an ongoing service with a first network according to a first subscription and the UE is configured with one or more UE capabilities for the ongoing service, the method comprising:
sending a first request to the first network, the first request requesting a reduction in the UE capabilities configured for the ongoing service to enable the UE to also communicate according to a second subscription; and
receiving a first acknowledgement from the first network, the first acknowledgement indicating whether the request for the reduction in the UE capabilities is accepted or rejected.

25. The method of Embodiment 24, wherein the first acknowledgement is received in a reconfiguration message for reconfiguring UE capabilities.

26. The method of Embodiment 24 or 25, wherein the first acknowledgement is received in a reconfiguration message that reconfigures the UE to restrict or disable one or more of the UE capabilities for the ongoing service.

27. The method of Embodiment 26, wherein the first acknowledgement indicates that the reconfiguration of the UE capabilities is responsive to the first request.

28. The method of Embodiment 25, 26 or 27, further comprising the step of:
reconfiguring the UE capabilities according to the received reconfiguration message.

29. The method of Embodiment 28, further comprising the step of:
communicating with the first network or a second network according to the second subscription.

30. The method of Embodiment 29, further comprising the step of:
sending a message to the first network or the second network indicating the UE capabilities configured for the ongoing service according to the second subscription.

31. The method of Embodiment 30, further comprising the step of:
receiving a second acknowledgement from the first network or the second network, the second acknowledgement indicating whether the configured UE capabilities are accepted or rejected.

32. The method of any of Embodiments 23-31, wherein the first request is UE assistance information.

33. The method of any of Embodiments 23-32, wherein the first acknowledgement is received in a Radio Resource Control, RRC, reconfiguration message.

34. The method of any of Embodiments 23-33, wherein the one or more UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

35. A method performed by a user equipment, UE, that is configured to simultaneously use two or more subscriptions to communicate with one or more networks, wherein the UE has a first ongoing service with a first network according to a first subscription and a second ongoing service with the first network or a second network according to a second subscription, and wherein one or more UE capabilities of the UE are restricted or disabled to enable the UE to communicate simultaneously according to the first subscription and the second subscription, the method comprising:
after ending the second ongoing service according to the second subscription, sending a first request to the first network, the first request requesting an increase in the UE capabilities configured for the first ongoing service; and
receiving a first acknowledgement from the first network, the first acknowledgement indicating whether the request for the increase in the UE capabilities is accepted or rejected.

36. The method of Embodiment 35, wherein the first acknowledgement is received in a reconfiguration message for reconfiguring UE capabilities.

37. The method of Embodiment 35 or 36, wherein the first acknowledgement is received in a reconfiguration message that reconfigures the UE to de-restrict or enable one or more of the restricted or disabled UE capabilities.

38. The method of any of Embodiments 35-37, wherein the first acknowledgement indicates that the reconfiguration of the UE capabilities is responsive to the first request.

39. The method of any of Embodiments 35-38, further comprising the step of:
reconfiguring the UE capabilities according to the received reconfiguration message.

40. The method of any of Embodiments 35-39, wherein the first request is UE assistance information.

41. The method of any of Embodiments 35-40, wherein the first acknowledgement is received in a Radio Resource Control, RRC, reconfiguration message.

42. The method of any of Embodiments 35-41, wherein the one or more restricted or disabled UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

43. A method performed by a user equipment, UE, that is configured to simultaneously use two or more subscriptions to communicate with one or more networks, the method comprising:
performing the method according to any of embodiments 23-34 to enable the UE to also communicate according to a second subscription; and
performing the method according to any of embodiments 35-42 after ending an ongoing service according to the second subscription.

44. A method performed by a user equipment, UE, that is configured to simultaneously use two or more subscriptions to communicate with one or more networks, wherein the UE has an ongoing service with a first network according to a first subscription and the UE is configured with one or more UE capabilities for the ongoing service, the method comprising:
receiving a reconfiguration message from the first network, the reconfiguration message comprising a first configuration and a second configuration, wherein the first configuration is to configure the UE with one or more UE capabilities, and the second configuration is to configure the UE to disable or restrict one or more of the UE capabilities;
selecting one of the first configuration and the second configuration to use for the ongoing service; and
sending an acknowledgement to the first network indicating the configuration selected for the ongoing service.

45. The method of Embodiment 44, wherein the acknowledgement is sent in a reconfiguration complete message.

46. The method of Embodiment 45, wherein the acknowledgement is sent in a Radio Resource Control, RRC, reconfiguration complete message.

47. The method of Embodiment 44, 45 or 46, further comprising the step of:
reconfiguring the UE capabilities according to the selected configuration.

48. The method of any of Embodiments 44-47, wherein the one or more UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

### Group B Embodiments

49. A method performed by a network node in a second network for communicating with a user equipment, UE, that is configured to simultaneously use two or more subscriptions to communicate with one or more networks, wherein the UE has an ongoing first service with a first network according to a first subscription, the method comprising:
establishing or resuming a second service with the UE according to a second subscription; and
receiving an indication from the UE that the UE has restricted capabilities for the second service.

50. The method of embodiment 49 further comprising:
receiving an indication of first capabilities that are supported in the second service or an indication of second capabilities that are restricted in the second service.

51. The method of embodiment 49 or 50 wherein the step of receiving an indication that the UE has restricted capabilities for the second service comprises:
receiving a 1-bit notification from the UE indicating that that the UE has restricted capabilities for the second service.

52. The method of embodiment 51 wherein the 1-bit notification is received in one of: an RRCSetupRequest message, an RRCResumeRequest message, RRCSetupComplete message, an RRCResumeComplete message or an RRCReconfigurationComplete message.

53. The method of embodiment 49 or 50 wherein the step of receiving an indication that the UE has restricted capabilities for the second service comprises:
receiving an information element from the UE indicating that that the UE has restricted capabilities for the second service.

54. The method of embodiment 53 wherein the information element is received in one of: RRCSetupComplete message, an RRCResumeComplete or message an RRCReconfigurationComplete message.

55. The method of embodiment 54 wherein the information element indicates that one or more types of capabilities are restricted.

56. The method of embodiment 52 or 53 when dependent on embodiment 26 further comprising: responsive to receiving the 1-bit notification in an RRCSetupRequest message or an RRCResumeRequest message, receiving, in a message, the indication of first capabilities that are supported in the second service or the indication of second capabilities that are not supported in the second service.

57. The method of embodiment 56 wherein the message comprises one of: an RRCSetupComplete message or an RRCResumeComplete message.

58. The method of embodiment 51 to 54 further comprising:
responsive to receiving the indication that the UE has restricted capabilities, configuring the UE with a basic configuration.

59. The method of embodiment 50 wherein the first capabilities that are supported in the second service are received in a UECapabilityInformation message.

60. The method of embodiment 59 further comprising receiving the indication of the first capabilities in response to transmitting a UECapabilityEnquiry message to the UE.

61. The method of embodiment 59 or 60 wherein the indication of the first capabilities comprises an indication that the first capabilities are a subset of a set of normal UE capabilities in the UECapabilityInformation message.

62. The method of embodiment 59 or 60 wherein the indication of the first capabilities comprises an indication of whether each of a set of normal UE capabilities is in the first capabilities.

63. The method of embodiment 50 wherein the first capabilities that are supported in the second service are received in a UEAssistanceInformation message.

64. The method of embodiment 63 further comprising configuring the UE to report the first capabilities in a UEAssistanceInformation message.

65. The method of any one of embodiments 53 to 55 when dependent on embodiment 50 further comprising:
receiving the indication of the first capabilities or the indication of the second capabilities responsive to transmitting a request to report first capabilities or second capabilities.

66. The method of embodiment 65 wherein the request to report first capabilities or second capabilities is transmitted in a UEInformationRequest.

67. The method of embodiment 66 wherein the indication of the first capabilities or the indication of the second capabilities is received in a UEInformationResponse message.

68. The method of any one of embodiments 49 to 67 when dependent on embodiment 50, wherein the indication of second capabilities that are restricted in the second service comprises one or more of:
a maximum aggregated bandwidth across all downlink and uplink carrier(s) of a first frequency range, FR1, and/or a second frequency range, FR2;
   a maximum number of downlink and uplink secondary cells in a master cell group and/or a maximum number of downlink and uplink primary cells and secondary cells in a secondary cell group for a first frequency range, FR1 and/or a second frequency range, FR2;
a maximum number of receiving, Rx, chains or panels for a second frequency range, FR2;
a list of carrier frequencies and/or carrier frequency combinations that need to be released
a list of band combinations on whether measurement gap/NCSG is needed for a target NR/E-UTRA band that need to be updated;
one or more restricted UE power classes for operation in the second network;
a restricted maximum uplink duty cycle, MUDC;
a restricted MIMO configuration for the UE operation in the second network;
restricted receiving, Rx, chains and/or panels for the UE operation in the second network;
a restricted UE receiver configuration for the UE operation the second network;
a restricted duplex mode, DM, for the UE operation in the second network;
restricted processing capability for the UE operation in the second network;
restricted sidelink (SL) operation in the second network when the UE operates in the second network;
restricted operation of Ultra-Reliable and Low Latency Communications (URLLC) in the second network when the UE operates in the second network;
a restricted measurement capability for the UE operation in the second network for NeedForGaps and/or NCSG (Network Controlled Small Gap) capability; and
restricted enhanced measurement capabilities for the UE operation in the second network, such as NeedForGaps and/or NCSG capability.

69. A method of embodiment 68 further comprising:
receiving timing information related to or associated with the second capabilities that are restricted in the second service.

70. The method of embodiment 69 wherein the timing information is associated with all of the second capabilities.

71. The method of embodiment 69 wherein the timing information is associated with a subset of the second capabilities.

72. The method of any one of embodiments 49 to 71 when dependent on embodiment 50 further comprising:
reconfiguring the UE based on the first capabilities or the second capabilities.

73. The method of embodiment 72 when dependent on one of embodiments 44 to 46 wherein the step of reconfiguring the UE based on the first capabilities or the second capabilities comprises reconfiguring the UE for a time period indicated by the timing information.

74. The method of any one of embodiments 49 to 73 further comprising:
notifying a second node in the second network that the UE capabilities are restricted.

75. The method of any one of embodiments 49 to 74 wherein the first network is the same as the second network.

76. A method performed by a radio access network, RAN, node in a first network, wherein a user equipment, UE, has an ongoing service with the first network according to a first subscription and the UE is configured with one or more UE capabilities for the ongoing service, the method comprising:
receiving a first request from the UE, the first request requesting a reduction in UE capabilities configured for the ongoing service to enable the UE to also communicate according to a second subscription; and
sending a first acknowledgement to the UE, the first acknowledgement indicating whether the request for the reduction in the UE capabilities is accepted or rejected.

77. The method of Embodiment 76, wherein the first acknowledgement is sent in a reconfiguration message for reconfiguring UE capabilities.

78. The method of Embodiment 76 or 77, wherein the first acknowledgement is sent in a reconfiguration message that reconfigures the UE to restrict or disable one or more of the UE capabilities for the ongoing service.

79. The method of Embodiment 78, wherein the first acknowledgement indicates that the reconfiguration of the UE capabilities is responsive to the first request.

80. The method of Embodiment 78 or 79, further comprising the step of:
reconfiguring the UE capabilities according to the sent reconfiguration message.

81. The method of Embodiment 80, further comprising the step of:
communicating with the UE according to a second subscription.

82. The method of Embodiment 81, further comprising the step of:
receiving a message from the UE indicating the UE capabilities configured for the communications according to the second subscription.

83. The method of Embodiment 82, further comprising the step of:
sending a second acknowledgement to the UE, the second acknowledgement indicating whether the configured UE capabilities are accepted or rejected.

84. The method of any of Embodiments 76-83, wherein the first request is UE assistance information.

85. The method of any of Embodiments 76-84, wherein the first acknowledgement is sent in a Radio Resource Control, RRC, reconfiguration message.

86. The method of any of Embodiments 76-85, wherein the one or more UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

87. A method performed by a radio access network, RAN, node in a first network, wherein a user equipment, UE, has a first ongoing service with the first network according to a first subscription and a second ongoing service with the first network or a second network according to a second subscription, and the UE is configured with one or more UE capabilities for the ongoing services, wherein one or more UE capabilities of the UE are restricted or disabled to enable the UE to communicate simultaneously according to the first subscription and the second subscription, the method comprising:
receiving a first request from the UE, the first request requesting an increase in the UE capabilities configured for the first ongoing service; and
sending a first acknowledgement to the UE, the first acknowledgement indicating whether the request for the increase in the UE capabilities is accepted or rejected.

88. The method of Embodiment 87, wherein the first acknowledgement is sent in a reconfiguration message for reconfiguring UE capabilities.

89. The method of Embodiment 87 or 88, wherein the first acknowledgement is sent in a reconfiguration message that reconfigures the UE to de-restrict or enable one or more of the restricted or disabled UE capabilities.

90. The method of any of Embodiments 87-89, wherein the first acknowledgement indicates that the reconfiguration of the UE capabilities is responsive to the first request.

91. The method of any of Embodiments 87-90, wherein the first request is UE assistance information.

92. The method of any of Embodiments 87-91, wherein the first acknowledgement is sent in a Radio Resource Control, RRC, reconfiguration message.

93. The method of any of Embodiments 87-92, wherein the one or more restricted or disabled UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes.

94. A method performed by a radio access network, RAN, node in a first network, wherein a user equipment, UE, has an ongoing service with the first network according to a first subscription and the UE is configured with one or more UE capabilities for the ongoing service, the method comprising:
performing the method according to any of embodiments 76-85 to enable the UE to also communicate according to a second subscription; and
performing the method according to any of embodiments 87-93 after the UE ends an ongoing service according to the second subscription.

95. A method performed by a radio access network, RAN, node in a first network, wherein a user equipment, UE, has an ongoing service with the first network according to a first subscription and the UE is configured with one or more UE capabilities for the ongoing service, the method comprising:
sending a reconfiguration message to the UE, the reconfiguration message comprising a first configuration and a second configuration, wherein the first configuration is to configure the UE with one or more UE capabilities, and the second configuration is to configure the UE to disable or restrict one or more of the UE capabilities; and
receiving an acknowledgement from the UE indicating the configuration selected for the ongoing service.

96. The method of Embodiment 95, wherein the acknowledgement is received in a reconfiguration complete message.

97. The method of Embodiment 96, wherein the acknowledgement is received in a Radio Resource Control, RRC, reconfiguration complete message.

98. The method of any of Embodiments 95-97, wherein the one or more UE capabilities comprise one or more of dual connectivity, DC; carrier aggregation, CA; Multiple-Input, Multiple-Output, MIMO; use of aggregated uplink, UL, and downlink, DL, bandwidth for Frequency Range 1, FR1, and/or Frequency Range 2, FR2 carriers; a number of DL and UL Secondary Cells, SCells, in a Master Cell Group, MCG, and Primary Secondary Cells, PSCells/Secondary Cells, SCell, in a Secondary Cell Group, SCG, for FR1 and/or FR2; carrier frequencies and/or carrier frequency combinations; and UE power classes

99. The method of any of the previous embodiments, further comprising:
obtaining user data; and
forwarding the user data to a host or a user equipment.

### Group C Embodiments

1. A computer program product comprising a computer readable medium having computer readable code embodied therein, the computer readable code being configured such that, on execution by a suitable computer or processor, the computer or processor is caused to perform the method of any of the Group A embodiments or the Group B embodiments.

2. A user equipment, UE, configured to perform the method of any of the Group A embodiments.

3. A user equipment, UE, comprising a processor and a memory, said memory containing instructions executable by said processor whereby said UE is operative to perform the method of any of the Group A embodiments.

4. A radio access network, RAN, node, configured to perform the method of any of the Group B embodiments.

5. A radio access network, RAN, node comprising a processor and a memory, said memory containing instructions executable by said processor whereby said RAN node is operative to perform the method of any of the Group B embodiments.

6. A user equipment, comprising:
processing circuitry configured to cause the user equipment to perform any of the steps of any of the Group A embodiments; and
power supply circuitry configured to supply power to the processing circuitry.

7. A network node, the network node comprising:
processing circuitry configured to cause the network node to perform any of the steps of any of the Group B embodiments; and
power supply circuitry configured to supply power to the processing circuitry.

8. A user equipment (UE), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

1. A method performed by a user equipment that is adapted to simultaneously use two or more subscriptions to communicate with one or more networks, wherein the UE has an ongoing first service with a first network according to a first subscription:
establishing or resuming a second service with a second network according to a second subscription; and
indicating to the second network that the user equipment has restricted capabilities for the second service, wherein the step of indicating comprises transmitting a 1-bit notification to the second network indicating that that the user equipment has restricted capabilities for the second service.

2. The method of claim 1 further comprising:
transmitting an indication of first capabilities that are supported in the second service or an indication of second capabilities that are restricted in the second service.

3. (canceled)

4. The method of claim 3 wherein the 1-bit notification is transmitted in one of: an RRCSetupRequest message, an RRCResumeRequest message, RRCSetupComplete message, an RRCResumeComplete message or an RRCReconfigurationComplete message.

5. The method of claim 1 wherein the step of indicating comprises:
transmitting an information element to the second network indicating that that the user equipment has different capabilities for the second service.

6. The method of claim 5 wherein the information element is transmitted in one of:
RRCSetupComplete message, an RRCResumeComplete message or an RRCReconfigurationComplete message.

7. The method of claim 5 wherein the information element indicates that one or more types of capabilities are different.

8-9. (canceled)

10. The method of claim 2 wherein the first capabilities that are supported in the second service are transmitted in a UECapabilityInformation message.

11-13. (canceled)

14. The method of claim 2 wherein the first capabilities that are supported in the second service are transmitted in a UEAssistanceInformation message.

15-17. (canceled)

18. The method of claim 2, wherein the indication of second capabilities that are restricted in the second service comprises one or more of:
a maximum aggregated bandwidth across all downlink and uplink carrier(s) of a first frequency range, FR1, and/or a second frequency range, FR2;
a maximum number of downlink and uplink secondary cells in a master cell group and/or a maximum number of downlink and uplink primary cells and secondary cells in a secondary cell group for a first frequency range, FR1 and/or a second frequency range, FR2;
a maximum number of receiving, Rx, chains or panels for a second frequency range, FR2;
a list of carrier frequencies and/or carrier frequency combinations that need to be released
a list of band combinations on whether measurement gap/NCSG is needed for a target NR/E-UTRA band that need to be updated;
one or more restricted UE power classes for operation in the second network;
a restricted maximum uplink duty cycle, MUDC;
a restricted MIMO configuration for the UE operation in the second network;
restricted receiving, Rx, chains and/or panels for the UE operation in the second network;
a restricted UE receiver configuration for the UE operation the second network;
a restricted duplex mode, DM, for the UE operation in the second network;
restricted processing capability for the UE operation in the second network;
restricted sidelink (SL) operation in the second network when the UE operates in the second network;
restricted operation of Ultra-Reliable and Low Latency Communications (URLLC) in the second network when the UE operates in the second network;
a restricted measurement capability for the UE operation in the second network for NeedForGaps and/or NCSG (Network Controlled Small Gap) capability; and
restricted enhanced measurement capabilities for the UE operation in the second network, such as NeedForGaps and/or NCSG capability.

19-22. (canceled)

23. A method performed by a network node in a second network for communicating with a user equipment, UE, that is adapted to simultaneously use two or more subscriptions to communicate with one or more networks, wherein the UE has an ongoing first service with a first network according to a first subscription, the method comprising:
establishing or resuming a second service with the UE according to a second subscription; and
receiving an indication from the UE that the UE has restricted capabilities for the second service, wherein the step of receiving comprises receiving a 1-bit notification from the UE indicating that that the UE has restricted capabilities for the second service.

24. The method of claim 23 further comprising:
receiving an indication of first capabilities that are supported in the second service or an indication of second capabilities that are restricted in the second service.

25. (canceled)

26. The method of claim 23 wherein the 1-bit notification is received in one of: an RRCSetupRequest message, an RRCResumeRequest message, RRCSetupComplete message, an RRCResumeComplete message or an RRCReconfigurationComplete message.

27. The method of claim 23 wherein the step of receiving an indication that the UE has restricted capabilities for the second service comprises:
receiving an information element from the UE indicating that that the UE has restricted capabilities for the second service.

28. The method of claim 27 wherein the information element is received in one of:
RRCSetupComplete message, an RRCResumeComplete message or an RRCReconfigurationComplete message.

29. The method of claim 28 wherein the information element indicates that one or more types of capabilities are restricted.

30-36. (canceled)

37. The method of claim 24 wherein the first capabilities that are supported in the second service are received in a UEAssistanceInformation message.

38. The method of claim 37 further comprising configuring the UE to report the first capabilities in a UEAssistanceInformation message.

39-41. (canceled)

42. The method of claim 24, wherein the indication of second capabilities that are restricted in the second service comprises one or more of:
a maximum aggregated bandwidth across all downlink and uplink carrier(s) of a first frequency range, FR1, and/or a second frequency range, FR2;
a maximum number of downlink and uplink secondary cells in a master cell group and/or a maximum number of downlink and uplink primary cells and secondary cells in a secondary cell group for a first frequency range, FR1 and/or a second frequency range, FR2;
a maximum number of receiving, Rx, chains or panels for a second frequency range, FR2;
a list of carrier frequencies and/or carrier frequency combinations that need to be released
a list of band combinations on whether measurement gap/NCSG is needed for a target NR/E-UTRA band that need to be updated;
one or more restricted UE power classes for operation in the second network;
a restricted maximum uplink duty cycle, MUDC;
a restricted MIMO configuration for the UE operation in the second network;
restricted receiving, Rx, chains and/or panels for the UE operation in the second network;
a restricted UE receiver configuration for the UE operation the second network;
a restricted duplex mode, DM, for the UE operation in the second network;
restricted processing capability for the UE operation in the second network;
restricted sidelink (SL) operation in the second network when the UE operates in the second network;
restricted operation of Ultra-Reliable and Low Latency Communications (URLLC) in the second network when the UE operates in the second network;
a restricted measurement capability for the UE operation in the second network for NeedForGaps and/or NCSG (Network Controlled Small Gap) capability; and
restricted enhanced measurement capabilities for the UE operation in the second network, such as NeedForGaps and/or NCSG capability.

43-63. (canceled)

64. A user equipment that is adapted to simultaneously use two or more subscriptions to communicate with one or more networks, the UE comprising processing circuitry adapted to cause the UE to:
when the UE has an ongoing first service with a first network according to a first subscription, establish or resuming a second service with a second network according to a second subscription; and
indicate to the second network that the user equipment has different capabilities for the second service, wherein indicate comprises transmitting a 1-bit notification to the second network indicating that that the user equipment has restricted capabilities for the second service.

65-71. (canceled)
